(19) United States
(12) Patent Application Publication
(10) Pub. No.: US 2008/0316111 A1
(43) Pub. Date: Dec. 25, 2008

(54) Antenna, antenna apparatus, and communication device

(75) Inventors: Hiroyuki Aoyama, Kumagaya-shi (JP); Masayuki Gonda, Kumagaya-shi (JP)

Correspondence Address: OLIFF & BERRIDGE, PLC, P.O. BOX 320850, ALEXANDRIA, VA, 22320-4850, US

(73) Assignee: HITACHI METALS, LTD., TOKYO (JP)

(21) Appl. No.: 12/153,884

(22) Filed: May 27, 2008

(30) Foreign Application Priority Data
May 28, 2007 (JP) 2007-140599
Aug. 27, 2007 (JP) 2007-219343
Jan. 11, 2008 (JP) 2008-004504
Mar. 21, 2008 (JP) 2008-074692

(51) Int. Cl. H01Q 1/38

(52) U.S. Cl. 343/700 MS

(57) ABSTRACT

An antenna is provided which includes a first antenna element having at least one base and a conductor penetrating through the base and a second antenna element having a conductor portion having a shape of a plate or a line and a connecting conductor, wherein a first end of the conductor of the first antenna element is connected to the connecting conductor of the second antenna element, and the connecting conductor of the second antenna element is connected to a partway on the conductor portion of the second antenna element.

The applications, from which priority are claimed, are incorporated herein by reference.

### BACKGROUND OF THE INVENTION

1. Field of the Invention

The present invention relates to an antenna which is used in an electronic device having a communication function, for example, a communication device such as a portable phone and a portable terminal device, and further to an antenna apparatus and a communication device which use the antenna.

2. Related Art

A communication device such as a portable phone and a wireless LAN has a usage frequency band of several hundreds of MHz to few GHz, and a high gain and a high efficiency in the band are desired. Therefore, an antenna which is used in the communication device is required to function with a high gain in the band, and, in addition, is also required to have a small size and a low height due to its usage form. Moreover, in recent years, there is a growing demand for handling, with one portable phone, 4 bands including a GSM band (810 MHz-960 MHz) and DCS/PCS and UMTS bands (1710 MHz-2170 MHz), that is, a quad-band, and it becomes necessary to cover a wider frequency band than the related art.

In the related art, a chip antenna which uses a dielectric ceramics is available as a small-size antenna suitable for mobile communication (for example, JP Hei 10-145123 A; hereinafter referred to as “Document 1”). Under a condition of a constant frequency, with the use of a dielectric with a higher dielectric constant, it is possible to reduce the size of the chip antenna. In Document 1, the wavelength is shortened by providing a meander line antenna. An antenna is also proposed which uses, in addition to the relative dielectric constant ∈r, a magnetic material with a large relative magnetic permeability μr, to shorten the wavelength by a factor of 1/(∈r·μr)^{1/2}, in order to reduce the size (for example, JP Sho 49-40046 A; hereinafter referred to as “Document 2”).

Furthermore, an antenna is proposed in which a portion comprising only a conductor and a portion which is a combination of a conductor connected to the conductor portion and a ceramics (Ni—Zn-based ferrite; that is, a magnetic material) are placed in series along a length direction of the antenna (JP Sho 56-64502 A; hereinafter referred to as “Document 3”).

Although these antennas are advantageous for reducing the size and lowering the height, the following problem arises in order to widen the band. For example, when a helical type radiating element is employed as the antenna line, when the number of windings in increased, a stray capacity between lines is increased and a Q value is increased. As a result, the band width is narrowed, and it becomes difficult to apply the device for usage such as a quad-band portable phone which requires a very wide band.

With the dielectric chip antenna or magnetic material chip antenna as described in Documents 1-3, the size can be reduced and the band can be widened. However, in a communication device, in particular, in a portable communication device, because a mounting space of electronic components forming the antenna is limited, the mounting space of the antenna must be further reduced. On the other hand, a uniform and high gain performance is required for each frequency band which is used in the portable communication device corresponding to the quad-band which particularly requires a very wide band. In other words, although an increase in number of the dielectric or the magnetic material portions for improving the performance is advantageous in improving uniform gain performance, there is a limit in the space due to a limited space. In addition, there had been a problem in that the gain reduction is large in the frequency band, in particular, in a low frequency side, used in the portable communication device in a structure with only a chip antenna which is formed with a dielectric ceramics or a magnetic material ceramics and a conductor provided within the ceramics.

In addition, although the use of the antenna element in which the dielectric ceramics or the magnetic material ceramics is combined with the conductor achieves a high gain in a particular frequency range within the band, a uniform high gain cannot be obtained over a range from a low frequency band to a high frequency band used in the portable communication device. In particular, there had been problems in that the antenna element is not suited for use such as a portable communication device corresponding to the quad-band which requires realization of a low VSWR and a high gain over a very wide band, in particular, in the high frequency band.

### SUMMARY OF THE INVENTION

An advantage of the present invention is that a built-in antenna, an antenna apparatus, and communication device which uses the antenna apparatus is provided which is suited for an efficient mounting in a housing of a portable communication device, for achieving a very wide band in a high frequency band, and realizing a multi-band.

According to one aspect of the present invention, there is provided an antenna comprising a first antenna element including a base and a conductor penetrating through the base, and a second antenna element including a conductor portion having a shape of a plate or a line and a connecting conductor. A first end of the conductor of the first antenna element is connected to the connecting conductor of the second antenna element, and the connecting conductor of the second antenna element is connected to a partway on the conductor portion of the second antenna element. In this structure, the antenna comprises a conductor portion and a base. Because the conductor portion is formed extending along two directions with different lengths from a connection point with the connecting conductor, resonances can be achieved corresponding to approximately λ/4 of two frequencies corresponding to the lengths of extension in the directions. In this structure, the second antenna element could correspond to the lower frequency band such as the GSM band with the first antenna element having the base. For example, when the antenna of the present invention is used in a low frequency band such as the GSM band used in the portable communication device, by providing the conductor portions in two directions with different lengths from the connection point with the connecting conductor, two resonance frequencies which slightly differ from each other can be realized. As a result, a low VSWR and a high gain can be obtained for a wider frequency band compared to a structure with only one resonance frequency, and a superior antenna characteristic can be achieved over a wide band. In addition, the base used in the first antenna element is not limited to a magnetic material ceramics, and an insulating material such as a dielectric ceramics may be used, which contributes to reduction in size and widening of the band. Because a line-shaped conductor is used as the conductor in the base and the conductor penetrates through the base, a stray capacity tends to not be formed, and the magnetic material portion can effectively function as an inductance component.

### BRIEF DESCRIPTION OF THE DRAWINGS

FIG. 1 is a diagram showing an antenna of a preferred embodiment according to the present invention.

FIG. 2 is a diagram showing an antenna of a preferred embodiment according to the present invention.

FIG. 3 is a diagram showing an antenna of a preferred embodiment according to the present invention.

FIG. 4 is a diagram showing an antenna of a preferred embodiment according to the present invention.

FIG. 5 is a diagram showing an antenna of a preferred embodiment according to the present invention.

FIG. 6 is a diagram showing an antenna of a preferred embodiment according to the present invention.

FIG. 7 is a diagram showing an antenna of a preferred embodiment according to the present invention.

FIG. 8 is a diagram showing an antenna of a preferred embodiment according to the present invention.

FIG. 9A is a diagram showing an example base which is used in an antenna of a preferred embodiment according to the present invention.

FIG. 9B is a diagram showing an example base which is used in an antenna of a preferred embodiment according to the present invention.

FIG. 9C is a diagram showing an example base which is used in an antenna of a preferred embodiment according to the present invention.

FIG. 10A is a diagram showing an example connection arrangement of bases in a preferred embodiment according to the present invention.

FIG. 10B is a diagram showing an example connection arrangement of bases in a preferred embodiment according to the present invention.

FIG. 11 is a diagram showing an example structure of a base which is used in an antenna of a preferred embodiment according to the present invention.

FIG. 12A is a diagram showing an example of fixing of a base which is used in an antenna of a preferred embodiment according to the present invention.

FIG. 12B is a diagram showing an example of fixing of a base which is used in an antenna of a preferred embodiment according to the present invention.

FIG. 12C is a diagram showing an example of fixing of a base which is used in an antenna of a preferred embodiment according to the present invention.

FIG. 13 is a diagram showing an example of fixing of an antenna element which is used in an antenna of a preferred embodiment according to the present invention.

FIG. 14 is a diagram showing an adjustment method of an antenna in a preferred embodiment according to the present invention.

FIG. 15 is a diagram showing an adjustment method of an antenna in a preferred embodiment according to the present invention.

FIG. 16 is a diagram showing an example of a matching circuit which is used in an antenna of a preferred embodiment according to the present invention.

FIG. 17A is a diagram showing an example of an antenna apparatus which uses an antenna of a preferred embodiment according to the present invention.

FIG. 17B is a diagram showing an example of an antenna apparatus which uses an antenna of a preferred embodiment according to the present invention.

FIG. 17C is a diagram showing an example of an antenna apparatus which uses an antenna of a preferred embodiment according to the present invention.

FIG. 18 is a diagram showing an example of an antenna apparatus according to the related art.

FIG. 19 is a diagram showing an actual measurement example of an average gain of an antenna apparatus of a preferred embodiment according to the present invention.

FIG. 20 is a diagram showing an actual measurement example of VSWR of an antenna apparatus of a preferred embodiment according to the present invention.

FIG. 21 is a diagram showing a resonance frequency of a conductor portion of a preferred embodiment according to the present invention.

FIG. 22 is a perspective view showing an example of an antenna of a preferred embodiment according to the present invention.

FIG. 23 is a plan view showing an example of an antenna of a preferred embodiment according to the present invention.

FIG. 24 is a perspective view showing an example of an antenna according to another aspect of a preferred embodiment of the present invention.

FIG. 25 is a perspective view showing an example of an antenna according to yet another aspect of a preferred embodiment of the present invention.

FIG. 26 is a perspective view showing an example of an antenna according to another aspect of a preferred embodiment of the present invention.

FIG. 27 is a plan view showing an example of an antenna according to another aspect of a preferred embodiment of the present invention.

FIG. 28 is a plan view showing an example of an antenna according to another aspect of a preferred embodiment of the present invention.

### DESCRIPTION OF PREFERRED EMBODIMENT

A preferred embodiment of the present invention will now be described with reference to the drawings. In the following description, the same reference numerals are assigned to the same members.

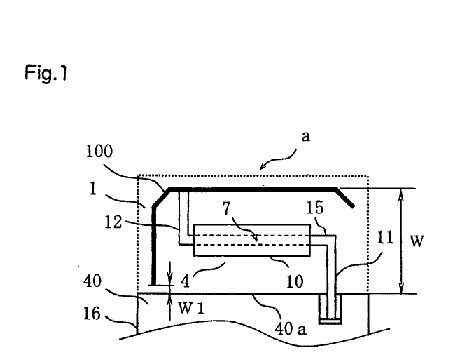

FIG. 1 shows one aspect of an antenna of a preferred embodiment according to the present invention. An antenna a of FIG. 1 is an antenna having a base (a magnetic material chip or a dielectric chip) and a conductor portion. The antenna can be mounted on a board and used. FIG. 1 is a plan view (which corresponds to a diagram of a board surface viewed from the above when the antenna is mounted on the board) of an antenna of the preferred embodiment.

As shown in FIG. 1, the antenna of the present embodiment comprises a first antenna element 4 having a first base 10 and a conductor 7 which is provided within the base 10, and a second antenna element 1 having a plate-shaped conductor portion 100 and a connecting conductor 12. The connecting conductor 12 is connected to a partway on the plate-shaped conductor portion 100. If the conductor portion 100 is formed with a metal conductive film or a wire (line-shaped), the degree of freedom of the shape of the antenna can be further improved, and the structure can be constructed to occupy less space. In the structure of FIG. 1, one side of the conductor portion 100 is placed along a longitudinal direction in parallel to and distanced from the first base 10, and a second end (other end) which is on a power supply side of the conductor 7 of the first base 10 is connected to a power supply line 11, and a first end (one end) which is on a non-power supply side is connected to the conductor portion 100 by the line-shaped connecting conductor 12. In the first antenna element 4, the conductor 7 penetrates through the base 10. Alternatively, the conductor 7 and the connecting conductor 12 may be connected by one continuous conductor. In other words, the connecting conductor 12 may be considered not as a constituent member of the second antenna element 1, but as a common constituent member of the second antenna element 1 and the first antenna element 4. This is also true for other aspects. By forming the conductors with a continuous, integral, and line-shaped conductor, it is possible to reduce the number of connections, resulting in simplification of manufacturing steps of the antenna or the communication device and improvement of the product reliability. In the structure of FIG. 1, because there is no third antenna element 21, a long length can be secured for the conductor portion 100, surrounding the first antenna element 4. Because of this, it is possible to handle a band such as a digital terrestrial television broadcasting band which has a lower frequency and a wider band than the GSM band.

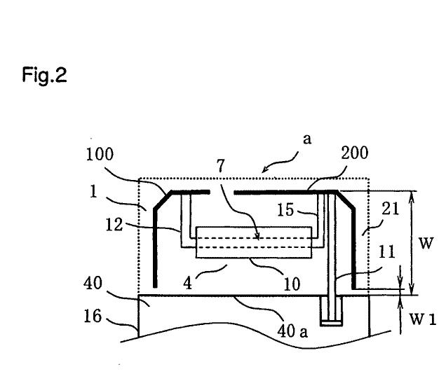

FIG. 2 shows another aspect of an antenna according to a preferred embodiment of the present invention. An antenna a of FIG. 2 is an antenna having a base (a magnetic material chip or a dielectric chip) and a conductor portion. The antenna can be mounted on a board and used. FIG. 2 is a plan view (which corresponds to a diagram of a board surface viewed from the above when the antenna is mounted on the board). The antenna of FIG. 2 comprises a first antenna element 4 having a first base 10 and a conductor 7 provided within the first base 10, a second antenna element 1 having a conductor portion 100 having a shape such as a plate or a line and a connecting conductor 12, and a third antenna element 21 having a conductor portion 200 having a shape such as a plate or a line and a connecting conductor 15. A first end of the conductor of the first antenna element 4 is connected to the connecting conductor 12 and a second end of the conductor of the first antenna element 4 is connected to the connecting conductor 15. The connecting conductor 12 is connected to a partway on the conductor portion 100 and the connecting conductor 15 is connected to a partway on the conductor portion 200. By forming the conductor portion with a metal conductive film or a wire (line shape) instead of the plate shape, it is possible to further improve the degree of freedom of the shape of antenna, and to construct the structure to occupy less space. In the structure of FIG. 2, conductor portions 100 and 200 are placed such that one side of each of the conductor portions 100 and 200 is placed along a longitudinal direction in parallel to and distanced from the first base 10, a second end which is on the power supply side of the conductor 7 of the first base 10 and the conductor portion 200 are connected by the line-shaped connecting conductor 15, and a first end which is on the non-power supply side and the conductor portion 100 are connected by the line-shaped connecting conductor 12. In the first antenna element 4, the conductor 7 penetrates through the base 10. Alternatively, the conductor 7 and the connecting conductors 12 and 15 may be connected by one continuous conductor.

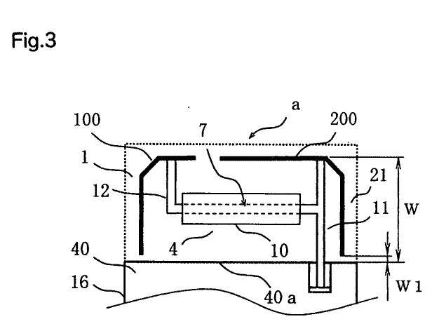

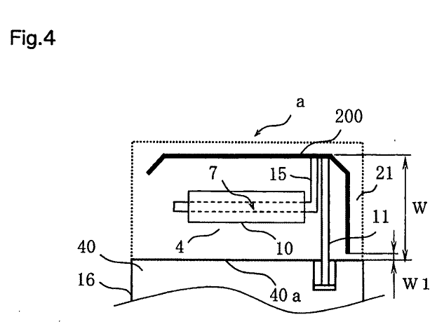

FIG. 4 shows another aspect of an antenna of a preferred embodiment according to the present invention. An antenna a of FIG. 4 is an antenna having a base (a magnetic material chip or a dielectric chip) and a conductor portion. The antenna a can be mounted on a board and used. The antenna a of FIG. 4 comprises a first antenna element 4 having a conductor 7 which is provided penetrating through a base 10, and a third antenna element 21 comprising a connecting conductor 15 and a conductor portion 200. A second end which is on the power supply side of the conductor 7 of the first antenna element 4 is directly connected to the conductor portion 200 by the connecting conductor 15 and a power supply line 11 is directly connected to the conductor portion 200 at a point different from a connection point of the connecting conductor 15. The conductor portion 200 is formed in a plate shape and in an approximate L shape. By forming the conductor portion with a metal conductive film or wire (line shape) instead of the plate shape, it is possible to further improve the degree of freedom of the shape of the antenna, and the structure can be formed to occupy less space. In the first antenna element 4, the conductor 7 penetrates through the base 10. Alternatively, the conductor 7 and the connecting conductor 15 may be realized by connection of one continuous conductor. Similar to FIG. 3, the connecting conductor 15 may be connected to a partway on the power supply line 11.

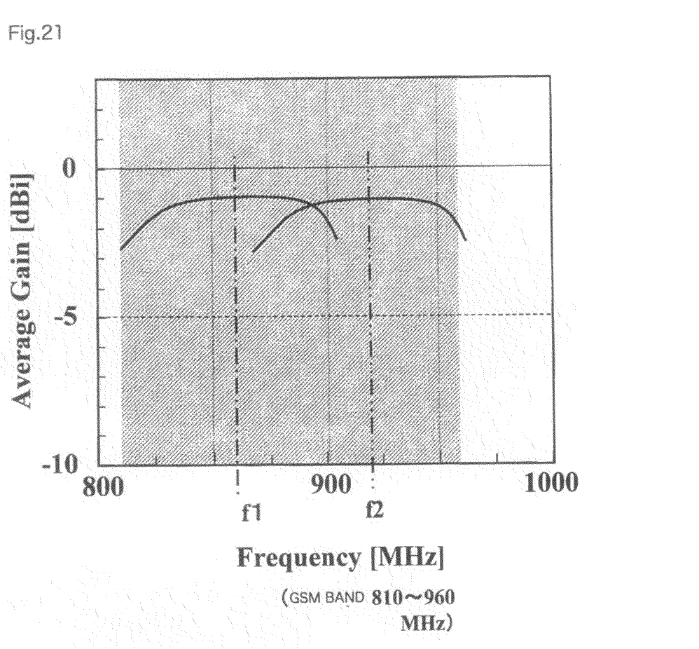

According to the antennas a of FIGS. 1-4, the base 10 and one side of the conductor portion 100 are placed distanced from a ground portion end 40a in FIGS. 1-3 and one side of the conductor portion 200 is placed distanced from the ground portion end 40a in FIGS. 2-4. In addition, in the portion of the base 10, a conductor is not wound around the base unlike the dielectric chip antenna and magnetic material chip antenna having a helical electrode, and, thus, stray capacities between lines tend to not be formed and the structure is superior for enlarging the band, as will be described below. Moreover, in FIGS. 1-3, on the side of the first end which is the non-power supply side of the conductor 7 of the first antenna element 4, the connecting conductor 12 which is a radiating electrode is connected to a partway on the conductor portion 100. In FIGS. 2-4, on the side of the second end which is the power supply side, the connecting conductor 15 is connected to a partway on the conductor portion 200. Therefore, compared to the dielectric chip antenna and magnetic material chip antenna of the related art, the antenna has a larger surface area of conductor portions. That is, because the conductor portions 100 and 200 are provided, the radiation resistance between the structure and the ground portion 40 of the main circuit board is increased and the radiation efficiency is improved. The conductor portions can be formed extending in two directions from the connection point with the connecting conductor with different lengths each corresponding to approximately λ/4 of the used frequency, and, thus, for example, resonances can be obtained at two frequencies f1 and f2 corresponding to the lengths, as shown in, for example, FIG. 21. As a result, a frequency band in which the VSWR is low and a high gain can be obtained can be widened compared to a structure with one resonance frequency. Thus, a superior antenna characteristic can be obtained over a wide band.

In the antennas a of FIGS. 1-4, to the second end side which is the power supply side of the conductor 7 of the first antenna element 4 and the first end side which is the non-power supply side, the conductor portion 100 and/or the conductor portion 200 having an overall approximate L shape are connected. For Example, in FIGS. 2-4, the second end side which is the power supply side of the conductor 7 of the first antenna element 4 is connected via the connecting conductor 15 to a partway on the conductor portion 200 and the third antenna element 21 is formed. In FIGS. 1-3, the first end side which is the non-power supply side of the conductor 7 is connected via the connecting conductor 12 to a partway on the conductor portion 100, and the second antenna element 1 is formed. With the conductor portions and connecting conductors, the second and third antenna elements are formed with an overall shape of an approximate T shape. Alternatively, the overall shape of the second and third antenna elements may be an approximate U shape, an approximate reversed V shape, or an approximate Y shape, corresponding to the shape of the housing of the portable communication device.

By branching the conductor portion into n sections (n=1, 2, . . . ) at the connection point between the conductor portion and the connecting conductor, to achieve slightly different lengths for n conductor portions, it is possible to realize a resonance at approximately λ/4 of each frequency. With this structure, because n resonance frequencies which slightly differ from each other are provided within one band, the frequency band in which the low VSWR and a high gain can be obtained for a wider frequency band as the number n is increased. In such a structure, interference between the conductor portions would occur more easily, but the branched conductor portions may be distanced apart by a certain distance in consideration of this.

A transmission/reception circuit or the like (not shown) is connected via the power supply line 11 to the conductor portion 100, and an antenna apparatus is constructed. In FIG. 2, the connecting conductor 15 is connected to the conductor portion 200. The power supply line 11 is also connected to the conductor portion 200. The power supply line 11, however, is connected to a point which differs from the connection point of the connecting conductor 15 to the conductor portion 200. As shown in FIG. 3, it is also possible to connect the second end side which is the power supply side of the conductor 7 to a partway on the power supply line 11. The connecting conductors 12 and 15 may be formed by a line-shaped or plate-shaped material or by a film-shaped conductive metal printed on a board.

In FIGS. 1-6, the components are connected and formed such that the connecting conductor 12 and standing plate-shaped conductor portion 100 form an approximate T shape on the first end side of the first antenna element 4 and the connecting conductor 15 and standing plate-shaped conductor portion 200 form an approximate T shape on the second end. Because the surface of the plate-shaped conductor portion 100 is placed to be perpendicular to the main circuit board surface on which the ground portion, 40 is formed, there are more metal conductor portions compared to an antenna with only the base (a magnetic material chip or a dielectric chip). As a result, the radiation resistance becomes small, and the radiation gain of the electromagnetic wave is increased over a wide frequency band. However, as the surface areas of the conductor portions 100 and 200 are increased in order to increase the radiation gain of the electromagnetic wave, the opposing area with the ground portion 40 of the main circuit board is increased because the conductor portion is standing, resulting in an increase in stray capacity. When the stray capacity is increased, a mirror image current of an opposite phase which cancels the resonance current of the antenna occurring in the conductor portions 100 and 200 tends to occur more easily in the ground portion 40, resulting in reduction in the gain of the antenna and narrowing of the bandwidth. Therefore, it is desirable that the area of the plate-shaped conductor portion 100 and the distance W from the ground portion end 40a be determined in balance to each other, to improve the radiation efficiency. As a method of not increasing the stray capacity other than the method to secure a certain distance for the distance W, a method may be employed in which the conductor portions 100 and 200 are formed with metal conductive films formed on the board or line-shaped conductors formed of a metal conductive line. With this method, because the surfaces of the plate-shaped conductor portions 100 and 200 become parallel to the ground portion 40, the radiation resistance can be reduced and a frequency band in which the VSWR is small can be enlarged even when the conductor portions 100 and 200 and the ground portion 40 are proximate to each other.

Next, a method for determining an optimum shape of the antenna a and determining a position relationship with other constituent components will be described. First, the conductor portion is formed in a shape of a square bracket, an arc (arch), or an L-shape corresponding to the space and shape of the housing. Then, the overall required length of the base is determined, and the number of divisions and arrangement are determined according to the space. Positions of the conductor portion and base are reviewed so that a bandwidth can be secured in which a radiation gain of a certain value or greater can be secured. Then, the shape of the conductor portion, whether the shape should be a plate, a line, or the like, is reviewed in order to reduce the stray capacity and based on the constraint condition of the housing. Next, a distance W to a surface of one side of the conductor portion opposing the ground portion end 40a is determined.

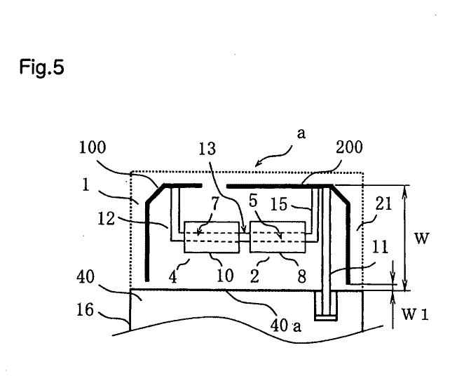

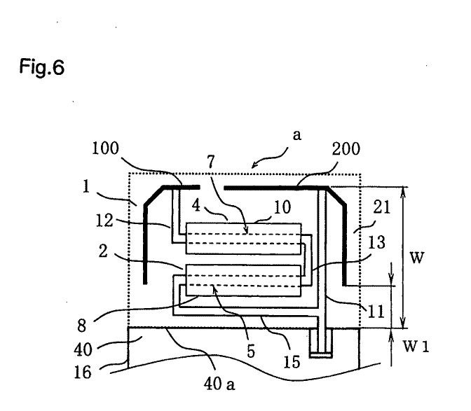

FIG. 5 shows another aspect of an antenna of a preferred embodiment according to the present invention. An antenna a of FIG. 5 is an antenna having a magnetic material chip or a dielectric chip as a base and a conductor portion. The antenna can be mounted on a board and used. FIG. 5 is a plan view (which corresponds to a diagram viewed from above the board surface when the antenna is mounted on the board). The antenna of FIG. 5 comprises a first antenna element 4 having a first base 10 and a conductor 7 provided within the first base 10, a fourth antenna element 2 having a second base 8 and a conductor 5 provided within the second base 8, a second antenna element 1 having a conductor portion 100 and a connecting conductor 12, and a third antenna element 21 having a conductor portion 200 and a connecting conductor 15. In the structure of FIG. 5, the base 10 and the base 8 which are arranged on a straight line and one side of each of the conductor portions 100 and 200 are placed along the longitudinal direction in parallel to and distanced from each other. The conductor 7 of the base 10 and the conductor portion 100 are connected by a connecting conductor 12, a second end on the power supply side of the conductor 7 of the base 10 and a first end which is on the non-power supply side of the conductor 5 of the base 8 are connected by a connecting conductor 13, and a second end of the conductor 5 of the base 8 which is on the power supply side is connected via a connecting conductor 15 to the conductor portion 200. The conductor portion 200 is connected via the power supply line 11 to a transmission/reception circuit or the like (not shown) and an antenna apparatus is constructed. In the first antenna element 4, the conductor 7 provided within the first base 10 penetrates through the base 10, and, in the fourth antenna element 2, the conductor 5 provided within the second magnetic base 8 penetrates through the base 8. Alternatively, the connecting conductor 12, the conductor 5, the connecting conductor 13, the conductor 7, and the connecting conductor 15 may be one continuous, connected conductor. As shown in FIG. 6, in the connecting conductor 15, the second end side which is the power supply side of the conductor 5 may be connected to a partway on the power supply line 11.

In the antenna a of FIG. 5, similar to the case of FIG. 1, the conductor portion 100 is placed distanced from the ground portion end 40a with a certain distance. The conductor of the antenna a penetrates through the board, and a conductor is not wound around the base unlike the dielectric chip antenna or magnetic material chip antenna having a helical electrode. Therefore, as will be described below, a stray capacity between lines of the helical electrode tends to be reduced, and the structure is a superior structure for widening the band. In addition, because a structure is employed in which the base is divided and the antenna elements are connected through the connecting conductors, the arrangement may be changed according to the mounting space such as arranging along the vertical direction as shown in FIG. 6, although FIG. 5 shows an arrangement in a straight line. In addition, by employing the structure of the divided base, the length of individual base may be reduced, resulting in an increase in structural strength and less tendency to break, and, consequently, improvement in reliability of the antenna. In other words, although the structure is an antenna which uses a base, the degree of freedom of mounting is very high. The reason why it is possible to provide a magnetic material chip antenna or a dielectric chip antenna having such a divided structure will be described later.

In the case of the antenna a of FIGS. 5 and 6, the second end side which is the power supply side of the conductor 5 of the fourth antenna element 2 is connected via the connecting conductor 15 to the conductor portion 200 which is a radiating electrode. In other words, the connecting conductor 15 and the conductor portion 200 are formed in an approximate T shape as an equivalent shape of the antenna element, to form the third antenna element 21. Moreover, the first end side of the conductor 7 of the first antenna element 4 which is the non-power supply side is connected via the connecting conductor 12 to the conductor portion 100 which is a radiating electrode. In other words, the connecting conductor 12 and the conductor portion 100 are formed in an approximate T shape as an equivalent shape of the antenna element, to form the second antenna element 1. This structure has two plate-shaped surfaces of conductor portions 100 and 200, and the radiation resistance between the structure and the ground portion 40 of the main circuit board is increased compared to the case having only one conductor portion, and, thus, the radiation efficiency is improved. In the antenna only having the base, the gain is reduced, but in this structure, because of the conductor portion, the reduction in gain can be prevented. In addition, in the conductor portions, because the lengths of the conductor portions extending from the connection points with the connecting conductors can be independently determined, resonances at a plurality of target frequencies can be easily obtained. The conductor portion 200 is connected via the power supply line 11 to a transmission/reception circuit (not shown), to form an antenna apparatus. When the conductor portions 100 and 200 are formed in a plate shape, because of a reason similar to that in the above-described first aspect, it is desirable that the surface of the plate shape be standing perpendicular to the main circuit board surface on which the ground portion 40 is formed, and a certain distance W is secured between the surface and the ground portion end 40a. The determination of the optimum shape of the antenna a and the position relationships with the other constituent components are similar to those in the first aspect, and will not be described again.

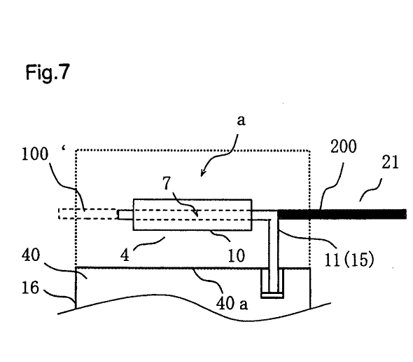

When only one resonance frequency is required at the conductor portion, as shown in FIG. 7, the conductor portions 100′ and 200 may be formed extending only in one direction from the connection points with the first end and the second end of the conductor 7. The extending portion may be a straight line or may be suitably flexible according to the shape of the housing. A portion with a dotted line shows an adjustment conductor portion 100′ for adjusting the resonance frequency. In this case, a resonance with the GSM band is realized with the base 10, the power supply line 11 (connecting conductor 15), and the adjustment conductor portion 100′ and a resonance with, for example, DCS/PCS and UMTS bands is realized with the power supply line 11 (connecting conductor 15) and the conductor portion 200. In this example case, the connecting conductor 15 appears to be connected to an end of the conductor portion 200, but because the λ/4 length is achieved including the power supply line 11 and the connecting conductor 15, that is, because the power supply line 11 is in effect included in the connecting conductor 15, the connecting conductor 15 may be considered as being connected to a partway on the conductor portion. A length of the adjustment conductor portion 100′ surrounded in FIG. 7 by dotted lines may be suitably changed based on a target frequency range in the GSM band. By forming the conductor portions 100′ and 200 with a metal conductive film or wire (line shape) instead of the plate shape, it is possible to further improve the degree of freedom of the shape of the antenna, and the structure can be constructed to occupy less space. Alternatively, the conductor 7, the power supply line 11 (connecting conductor 15), and conductor portions 100′ and 200 may be one connected continuous conductor.

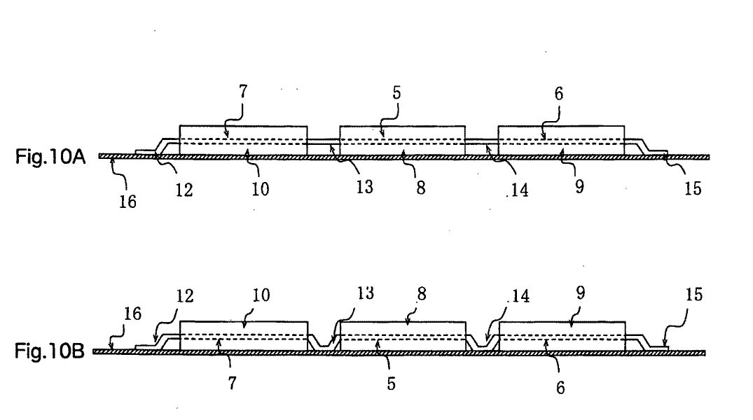

When a dielectric is used as a base in the bases of the first antenna element 4 and the fourth antenna element 2, because a dielectric is present around the entire periphery of the conductor penetrating through the dielectric, the effective dielectric constant of the base is increased. When the magnetic material is used as the base, because the magnetic material is present around the entire periphery of the conductor penetrating through the magnetic material, the magnetic field is formed coaxially around the conductor, and, thus, the magnetic permeability of the base is increased. Therefore, in both cases where the base is a dielectric and the base is a magnetic material, a wavelength shortening effect occurs and the size of the overall antenna can be reduced. When a conductor is wound around the base, compared to the structure in which the conductor is not provided through the base, the size of the overall antenna element can be reduced when a conductor length which is identical to the conductor length required for winding a conductor is secured. In addition, an electrical connection or junction with other circuit element or electrode is possible using the second end or the first end of the conductor, which results in an improvement in the degree of flexibility of design and in the fixing strength. In the structure of FIGS. 1-8, both sides of the conductor project from the base. The sides of the conductor do not need to project, but, in this case, an external electrode for connection with the conductor must be provided. In such a case, for example, as shown in FIG. 10A, and 10B, the external electrode of the antenna element may be soldered along with the external electrodes of the other antenna elements to an electrode provided on the board so that the antenna elements are connected in series. The electrode forming the connecting conductor provided on the board may be formed by a printed conductor pattern such as a metal conductive film.

As described, in the structures of FIGS. 1-8, because the conductors and the connecting conductors are constructed by one conductive line, the conductor 5 projecting from the second end which is on the non-power supply side of the base 8 and the conductor 7 projecting from the second end which is on the power supply side of the base 10 are common, and this conductor also functions as the connecting conductors 12, 13, and 15. The connecting conductor and the projecting portion of the conductor do not need to be formed by one conducting line. For example, the conductor 7 penetrating through the first base 10 and projecting from the first end which is on the power supply side of the base 10 and the first end which is on the non-power supply side of the conductor 5 which penetrates through the base 8 and projecting from the base 8 may be connected using a connecting conductor which is a separate member from the conductor. Alternatively, a structure may be employed in which an electrode provided on the board is used as the connecting conductor which is the separate member as shown in FIG. 10B and the connecting conductors 13 and 14 projecting to the electrode are soldered to the conductor portion of the board 16. However, in the structure in which the conductors and the connecting conductors are formed by one conductive line, that is, by an integral, continuous, line-shaped conductor, the number of connections can be reduced, and, consequently, the manufacturing steps can be simplified and the product reliability can be improved for the antenna and the communication device. In the case of the structure of FIG. 10B, the two bases are arranged with the longitudinal direction being parallel with one side of each of the conductors 100 and 200, the base 8 and the base 10 are arranged to be connected by the connecting conductor 13, the base 9 and the conductor portion 100 (not shown) are arranged to be connected by the connecting conductor 12, and the base 10 and the conductor portion 200 (not shown) are arranged to be connected by the connecting conductor 15. In the overall arrangement, the bases are placed with a suitable spacing therebetween, the base and the conductor portion are paced with a suitable spacing therebetween, and the base, the connecting conductor, and the conductor portion are connected in series.

In the structure of FIG. 6, similar to the structure of FIG. 3, the conductors and the connecting conductors may be formed with one conductive line or the conductive lines may be connected. Two bases 8 and 10 are placed so that the longitudinal direction is parallel to one side of each of the conductor portions 100 and 200. The connecting conductor 13 connects the base 8 and the base 10. The connecting conductor 15 connects the base 8 and the conductor portion 200. The connecting conductor 12 connects the base 10 and the conductor portion 100. The overall structure including the base, connecting conductor, and conductor portion is formed in an approximate meander shape. The connecting conductor 15 is connected to a partway on the power supply line 11 similar to FIG. 3, but may alternatively be directly connected via the connecting conductor 15 to the conductor portion 200 as shown in FIG. 5.

An example of another aspect of an antenna according to the embodiment will now be described with reference to FIG. 6. Although in the structure of FIG. 6, the base 10, base 9, and base 8 and the one side of each of the conductor portions 100 and 200 are placed with the longitudinal directions parallel to and distanced from each other, it is also possible to place, for example, a fifth antenna element 3 (not shown) having the same structure as the fourth antenna element 2 below the fourth antenna element 2. In addition, a plurality of sixth antenna elements 3′ (not shown) having the same structure as the fifth antenna element 3 may be provided below the fifth antenna element 3 in parallel to and distanced from each other and the antenna elements may be connected in series by the connecting conductors, to realize an overall meander shape.

The material of the base used in the antenna elements 2, 3, and 4 and the antenna element 3′ may be the same or different from each other. The conductor 7 provided within the first base 10 penetrates through the base 10 in the first antenna element 4, the conductor 5 provided within the second base 8 penetrates through the base 8 in the fourth antenna element 2, and the conductor 6 (not shown) provided within the third base 9 (not shown) penetrates through the base 9 in the fifth antenna element 3. The power supply line 11, the conductor 6, the connecting conductor 14, the conductor 5, the connecting conductor 13, the conductor 7, and the connecting conductor 12 are constructed to be connected in series in this order, but may alternatively be formed with one continuous conductor. The second end of the conductor 6 which is on the power supply side is connected to a partway on the power supply line 11 similar to FIG. 2, but may alternatively be connected via the connecting conductor 15 to the conductor portion 200.

When the base is a magnetic material chip, because a ceramics is the base material for the base, the base may be broken when an excessive impact is applied. In the communication device, in particular, in the portable communication device, because impact such as falling is applied, in order to improve the reliability of the antenna, a higher shock resistance is desired. By shortening the magnetic base in the longitudinal direction, the reliability of the magnetic base against an external force can be improved. For example, an equation of a bending strength S with respect to a maximum load N when the width is w, the thickness is t, and the distance between pivots is d is S=3Nd/(2 wt²). That is, the maximum tolerable load is N=2Swt²/(3d), which is proportional to a ratio between the width and the distance between pivots. In the case of falling of the communication device, because the direction of the external force applied to the magnetic material chip antenna is not constant, a cubic shape is considered to be an ideal shape in view of the strength. In this case, the ratio between the width and the distance between pivots (which, in this case, corresponds to the length of the magnetic base) w/d is 1. Because the antenna of the embodiment may have a structure in which the antenna is divided into a plurality of antenna elements, the ratio w/d can be set to a value close to 1 (that is, by setting the shape to be more like a cube) so that the strength is improved. Next, a specific example in which the base is divided will be described.

A structure having antenna elements 2, 3, 3′, and 4 may be considered as having a structure in which one line-shaped conductor penetrates through the base and the base portion of the antenna element is divided into 3 sections, but, as described above, the number of antenna elements is not limited to 1 and 2, and may be set to 3 or larger. In other words, by increasing the number to 3, 4, 5, . . . , it is possible to shorten the length of each base portion, and to connect the plurality of antenna elements in a beaded manner. With such a structure, it is possible to obtain a higher degree of freedom for arrangement of the antenna without reducing the performance of the antenna using the base.

As described, in the structure divided into antenna elements 2, 3, 3′, and 4, because the conductors and the connecting conductors are formed by one conductive line, the conductor portion projecting from the first end of the base 9 (not shown) which is on the non-power supply side and the conductor portion projecting from the second end of the base 8 which is on the power supply side are common, and these portions also function as the connecting conductor 14. Similarly, the conductor portion projecting from the first end of the base 8 which is on the non-power supply side and the conductor portion projecting from the first end of the magnetic base 10 which is on the power supply side are common, and these portions also function as the connecting conductor 13. However, the connecting conductor and the projecting portion of the conductor do not need to be formed by one conductive line. For example, a conductor penetrating through the base and projecting from the end of the base and a conductor penetrating through another base and projecting from the base may be connected using a connecting conductor which is a separate member from the conductors. Alternatively, a structure may be employed in which an electrode provided on the board as shown in FIG. 10A or 10B is used as the connecting conductor which is the separate member and the projecting conductor portion is soldered to the electrode. Furthermore, a configuration may be employed in which a board having a plurality of through holes and an electrode electrically connecting the through holes is used, the projecting conductor portion is inserted into the through hole, and the conductors are connected through soldering. With such a method, the base (chip) can be more firmly fixed on the board which is used in the communication device. However, by employing the configuration in which the conductors and the connecting conductors are formed with one continuous line-shaped conductor, it is possible to reduce the number of connections, and, consequently, simplify the manufacturing steps and improve the product reliability for the chip antenna and the communication device.

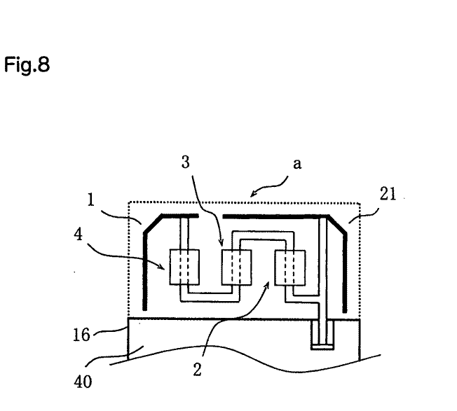

The arrangement of the first antenna element 4, the fourth antenna element 2, the fifth antenna element 3 (not shown), and the sixth antenna element 3′ (not shown) may be a bent shape or a meander shape, an L-shape, a crankshaft shape, or an arc shape. With such a structure, because the antenna has a connecting conductor portion between a plurality of antenna elements, the antenna elements can be connected via the connecting conductor portions, and the antenna elements can be arranged in a shape such as the bent shape or meander shape, the L-shape, the crankshaft shape, or the arc shape. The arrangement of the bent shape indicates an arrangement in which the longitudinal directions of an antenna element and another antenna element have a predetermined angle from each other. For example, the arrangement may be a V shape or a U shape. The meander shape indicates an arrangement in which an antenna element and another antenna element are connected by a connecting conductor which is bent in an approximate S shape and the antenna elements are arranged such that the longitudinal directions of the antenna elements are parallel to each other. Another preferred embodiment of the antenna of the present invention will now be described with reference to FIG. 8. In the structure of FIG. 8, a plurality of bases are placed so that the meandering direction is 90 degrees rotated from that in FIG. 6. In this case, the sizes of the first antenna element 4, fourth antenna element 2, and fifth antenna element 3 are preferably 3 mm-8 mm in length and 2 mm-4 mm in diameter. With such a structure, the shape of the antenna apparatus can be adapted for the mounting space defined by a curved surface such as an end portion in a housing of a portable communication device and the antenna apparatus can be mounted in the mounting space, and, thus, the spatial usage efficiency of the communication device can be improved.

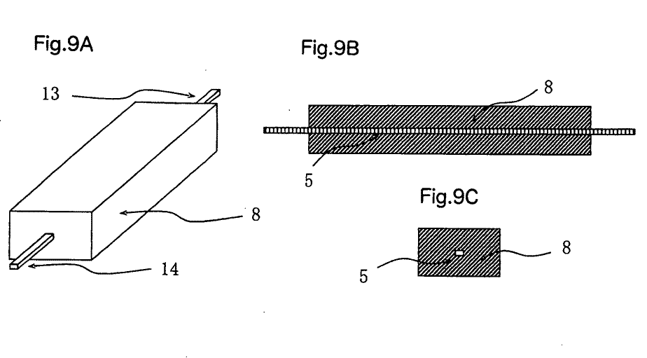

Next, the individual antenna element will be described. FIG. 9A-9C shows an example of an antenna element in which the base of the antenna is a magnetic material chip. FIG. 9A shows a perspective view, FIG. 9B shows a cross sectional view along the longitudinal direction including the conductor, and FIG. 9C shows a cross sectional view in a direction perpendicular to the longitudinal direction. The structure of FIGS. 9A-9C is an example of the fourth antenna element. A conductor 5 which has a straight line shape penetrates through a base 9 which has a rectangular parallelepiped shape in the longitudinal direction of the base 8. The straight line-shaped conductor 5 extends along an external surface of the base positioned to surround the conductor such as a side surface of the rectangular parallelepiped and an outer peripheral surface of a circular column, and penetrates between end surfaces of the base along the longitudinal direction. In the base, it is desirable that there is no conductor portion in a direction perpendicular to the extending direction of the linear element of the line-shaped conductor. For example, in the structure of FIG. 6, both ends of the conductor, that is, the first end and the second end of the conductor 5 project from the base 8. In the base 8, because only a hollow conductor 5 having a straight line shape is present as a conductor portion, such a structure is ideal for reducing the stray capacity. Because the base has a structure in which a straight line-shaped conductor which functions as a radiation conductor penetrates and there is substantially no portion opposing the conductor within the base, the structure is particularly effective in reducing the stray capacity. From this point of view, the number of conductors penetrating through the base is desirably 1. However, when the influence of the stray capacity is small because a sufficient space is provided or the like, an alternative structure may be employed in which another conductor penetrates through or is embedded in the base, in addition to the penetrating conductor. This structure can be similarly applied to the first, fourth, fifth, and sixth antenna elements.

Because the conductor 5 having a straight line shape penetrates through the base 8, compared to a case where a conductor is wound around the base, the size of the overall antenna element can be reduced when a penetrating conductor length which is equivalent to the conductor length required for winding the conductor is secured. In addition, because the conductor 5 having the straight line shape penetrates through the base 8, junction and electrical connection with other antenna elements, circuit elements, and electrodes on both ends of the straight line-shaped conductor 5 are possible, and the degree of flexibility for design is high. The straight line-shaped conductor desirably penetrates through the center axis of the base while maintaining a constant distance from the outer surface of the base in order to form the magnetic field around the conductor. In the structure of FIG. 10A, the straight line-shaped conductors 5, 6, and 7 penetrate the bases 8, 9, and 10 in the longitudinal direction and on the center axis of the magnetic bases. In other words, the straight line-shaped conductors 5, 6, and 7 are positioned on the center axis in the cross section of the bases 8, 9, and 10 perpendicular to the longitudinal direction.

Next, an advantageous point of the structure of the antenna of the preferred embodiment according to the present invention will be described. Because the antenna of the preferred embodiment according to the present invention is an antenna in which a plate-shaped or line-shaped conductor portion is added to a base of the magnetic material chip antenna, first, the advantage by the magnetic material chip antenna portion will be described. For example, the frequency bands of the GSM band (810 MHz-960 MHz) and DCS/PCS and UMTS bands (1710 MHz-1270 MHz) which are used in portable phones are 150 MHz-500 MHz and wide, and the frequency bands are separated by 1000 MHz. In order to achieve a predetermined communication quality over the entire band, a constant gain must be maintained over the entirety or each of the frequency bands. In order to widen the band, the Q value of the antenna must be reduced. The Q value is represented, when the inductance is L and the capacitance is C, by (C/L)^{1/2}, and, thus, the inductance L must be increased and the capacitance C must be reduced. When a dielectric is used as the base, the number of windings of the conductor must be increased in order to increase the inductance L. However, the increase in the number of windings results in an increase in stray capacity between lines, and, thus, the Q value of the antenna cannot be effectively reduced.

In the preferred embodiment according to the present invention, as described above, an antenna element is employed having a structure in which the straight line-shaped conductor penetrates through a magnetic base, which is effective in reducing the stray capacity, and, thus, the inductance L can be increased by the magnetic permeability without increasing the number of windings. Therefore, the Q value can be reduced while avoiding the increase in the stray capacity between lines due to the increase in the number of windings, and the structure enables significant advantages in particular for widening of the band of the antenna. For example, in the case of the conductor 5 of the fourth antenna element 2, the magnetic path is formed in the base around the conductor 5, and a closed magnetic path is formed. The inductance component L obtained in this structure depends on the length and cross sectional area of the base portion covering the conductor 5. Therefore, because the fourth antenna element 2 has a structure having an antenna element in which the conductor 5 penetrates through the base 8 on the center axis of the cross section, the L component can be efficiently secured and the size of the antenna can be reduced. Although a similar advantage can be obtained with the use of a dielectric as the base, the stray capacity between lines is increased by the winding of the conductor in the case of the dielectric, and the use of the magnetic base is more advantageous in order to further widen the frequency band.

In addition, as described above, in the preferred embodiment according to the present invention, because the magnetic paths in the antenna elements 2, 3, 3′, and 4 are formed around the center axes of the conductors 5, 6, and 7, even when the base is divided into a plurality of sections along the longitudinal direction of the conductor, the influence of the division on the formation of the inductance component L is very small in principle. Because of this, the antenna can be constructed with the base divided into a plurality of sections. When, on the other hand, the antenna is formed by winding a helical electrode on a base such as in the case of a dielectric, the magnetic path in the base is formed along the axial direction of the coil (penetrating along the longitudinal direction of the base), and, if the base is divided, the magnetic path is cut and the L component is significantly reduced. Therefore, even if a helical electrode is formed on each divided base, a chip antenna cannot be simply constructed in which the base is divided into a plurality of sections.

An advantage of a combination of the conductor portion and the base (magnetic material chip) will next be described in detail. In an antenna of the related art which comprises only the base and the conductor penetrating through the base, although a gain of the overall band can be improved, the gain is slightly inferior compared to an antenna comprising only the plate-shaped or line-shaped conductor portion, and the reduction in the gain is significant in the lower side frequency compared to the center frequency of each of the frequency bands used in the portable communication device. Therefore, by providing a conductor portion having a plate shape, a line shape, or the like on the power supply side and/or non-power supply side of the conductor of the first antenna element 4 as described above, it is possible to improve the gain and widen the frequency bands. In addition, by connecting the conductor portion 200 having a plate shape, a line shape, or the like on the power supply side of the conductor of the first antenna element 4 and the connecting conductor to a partway on the conductor portion, and providing the conductors to extend along two directions from the connecting point with lengths slightly different from each other and corresponding to approximately λ/4 of the used frequencies, it is possible to easily achieve, for example, resonances at two frequencies f1 and f2 corresponding to the lengths, as shown in FIG. 21, and, consequently, the frequency band can be further widened. As a result, compared to the antenna comprising only the base and the conductor penetrating through the base, for example, the gain at a lower side frequency in a high frequency band such as the DCS/PCS band and UMTS band can be improved. Furthermore, by providing the conductor portion 100 having a plate shape, a line shape, or the like on the non-power supply side of the conductor of the first antenna element 4, it is possible to improve, by a combination of the conductor portion 100 and the first antenna element 4, the gain also in the lower side in the low frequency band such as the GSM band. Because multiplex resonance occurs between the base and the sections of the conductor portion 200 which are parallel to the base, VSWR can be reduced and a high gain can be obtained in particular over the entire band of the DCS/PCS band and UMTS band which are the high frequency bands and wide bands. In other words, in all bands, the frequency band in which the VSWR is low is widened and the radiation gain of the electromagnetic wave can be improved.

The connection of the conductor at the outside of the base may be achieved by forming a printed electrode (metal conductive film) on a surface of the board on which the conductor appears. In other words, a printed electrode formed on the surface and the electrode printed on the board surface in contact with this surface can be fixed through soldering. On the other hand, in the viewpoint of simplifying the manufacturing steps and inhibiting the increase in the capacity, it is desirable to realize the connection through soldering or the like with the use of the projecting end of the conductor. When the connection is to be achieved outside of the base with the printed electrode, the printed electrode is preferably formed with a minimum area and minimum opposing portion. When both ends of the conductors 5 and 7 project such as in the structure of FIG. 6, the connecting conductors 13 and 15 connected to the conductor 5, the connecting conductors 12 and 13 connected to the conductor 7, and the antenna elements comprising bases 8 and 10 can be fixed with solder, and, thus, a stable mounting is possible. These conductors may alternatively be one continuous conductor. The projecting ends of the conductor do not need to be in a straight line shape, and may be bent.

FIG. 10A and 10B show examples of mounting of the magnetic material chip antenna on the board. In the structure of FIG. 10A, the connecting conductors 12, 13, 14, and 15 are bent toward the mounting surface side of the bases 10, 8, and 9 at a section distanced from the bases 10, 8, and 9, respectively, in order to allow easier mounting on the board. The tip portions of the connecting conductors are positioned in parallel to the bottom surface which is one end surface of the base, more specifically, on an approximate same plane. With the bent section being distanced from the end surface of the base, the increase in the capacity is inhibited, and chipping of the base and damages of the conductor at the boundary between the conductor and the base are inhibited. The connecting conductors 13 and 14 which also function as the projecting end are formed in a straight line shape viewed from the side surface of the board. The connecting conductor 12 and the connecting conductor 15 of the conductor 6 can be joined to the conductor portion of the board by solder or the like. FIG. 10B shows an example structure in which the connecting conductors 13 and 14 are also bent toward the mounting surface side of the bases 8, 9, and 10. The bending of the connecting conductor is desirably applied at a section distanced from the base, similar to the case of the connecting conductors 12 and 15.

When the connection of the conductor is to be achieved using the projecting end of the conductor, because no electrodes needs to be formed on the surface of the base in any case, the increase in the stray capacity can be inhibited. In the structure in which the projecting conductor portion has a straight line shape as in the preferred embodiment of FIGS. 1-8, because there is no portion in the base and on the surface of the base in which the conductors oppose each other, such a structure is particularly advantageous in reducing the stray capacity.

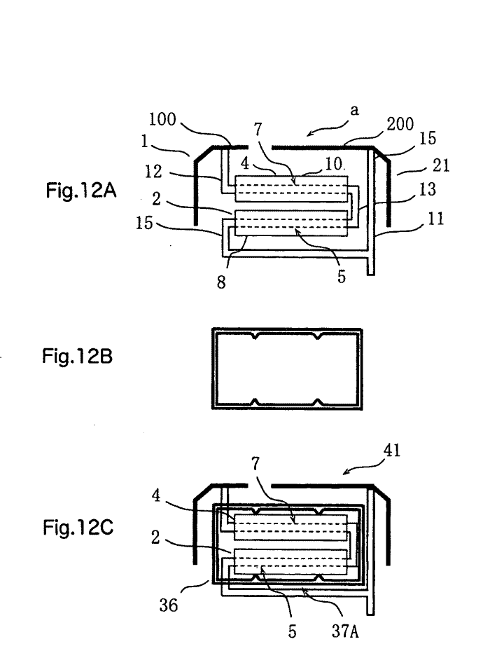

Another aspect of an antenna of a preferred embodiment according to the present invention is shown in FIGS. 12A-12C. FIG. 12A shows an example structure of an antenna a comprising a first antenna element 4, a second antenna element 1, a third antenna element 21, and a fourth antenna element 2. In addition, the first antenna element 4 and the fourth antenna element 2 each of which has a base are stored in a case 36. FIG. 12B shows a resin case 36 for storing the first antenna element 4 and the fourth antenna element 2. FIG. 12C is a plan view of the antenna 41 stored in the case 36. The case 36 has a space along the depth direction which can store the antenna element, and slits are formed on both side surfaces from an upper part of the side surface to the approximate center so that the connecting conductors 12 and 15 can be extended from the inside of the case to the outside of the case. Alternatively, a through hole may be provided in place of the slit. The slit or the through hole does not need to be formed on both side surfaces and may alternatively be provided only on one of the side surfaces. In the case 36, at two points along the longitudinal direction of the antenna element, there are projections 37A which constrain, movement of the antenna elements in a direction perpendicular to the longitudinal direction is provided on the inner wall of the case. In the example of FIG. 8, the projection 37A is formed in the depth direction in a column shape, and constrains the antenna element with a line. The cross sectional shape of the projection having the column shape is not particularly limited, and may be, for example, a triangular shape, a semicircle shape, or the like. The projection may alternatively be formed as a point-shaped projection and constrain the movement.

Alternatively, in place of providing the projection, it is also possible to provide a space having a shape which is approximately the same as the shape of the antenna element having the base and insert the antenna element into the space to constrain movement of the antenna element. In addition, it is also possible to constrain the movement of the antenna element using a case having a flat plate shape and on which only a projection is formed. A depth of the case is not particularly limited, but from the viewpoint of the protection of the bases 8 and 10, it is desirable that the depth is larger than the thickness of the base so that the base does not project outside from the upper surface of the case. The antenna element may be fixed on the board or the case by an adhesive. Because a plurality of the antenna elements are used in the antenna of the embodiment, the position is easily shifted. With the use of the structure having the case, the position relationship among the plurality of the antenna elements can be maintained. In such a case, for example, the conductor member may be fixed with a resin mold or the conductor member may be set to have an electrode pin structure and may project from the case. In addition, a lid member may be provided at the upper portion of the case. The lid member may be adhered and fixed by an adhesive or may have a structure to be hung on the case. By providing the lid member, it is possible to protect the entire antenna element. Moreover, it is also possible to use the lid member in addition to or in place of the formation of the projection, to constrain the movement of the antenna element.

The above-described example is an example configuration in which the movement of the antenna element having a base is constrained with a case. Alternatively, a configuration may be employed in which the entire antenna element is molded with a resin in place of using the case. For example, the group of antenna elements shown in FIG. 6 are inserted into a mold, a resin is filled, and the antenna element which are resin-molded are obtained. In this case, the conductor projecting from the base is configured to extend to the outside of the resin. Alternatively, it is also possible to assemble the conductor portion and the base on a resin structure which is formed in a manner to allow mounting of the conductor portion and the base in advance.

Next, a member forming the antenna will be described. The material of the conductor portion is not particularly limited, and, for example, when the conductor portion is formed with a plate-shaped sheet metal of a conductive line, in addition to metals such as Cu, Ag, Ni. Pt, Au, and Al, alloys such as 42 alloy, Kovar, phosphor bronze, brass, and a Corson series copper alloy may be used. Among these materials, conductive materials having a low hardness such as Cu is suitable for use with bending of the ends of the conductor portion or the like, and the conductive materials having a high hardness such as the 42 alloy, Kovar, phosphor bronze, and Corson series copper alloy are suitable for use as a member which firmly supports the base.

As the materials of the conductor to be used penetrating through the base, it is desirable to use a conductive material having a high hardness such as the 42 alloy, Kovar, phosphor bronze, and Corson series copper alloy. These materials are particularly suited for use in a straight line shape without the bending of the ends of the conductor. An insulating cover such as polyurethane and enamel may be provided on the conductor. For example, although it is possible to secure insulation without the use of the insulating cover by using, as the base, a magnetic base having a high volume resistivity, for example, 1×10⁵Ω·m or greater, by providing the insulating cover, a particularly high insulating characteristic can be obtained. In this case, a thickness of the insulating cover is desirably 25 μm or less. When the thickness is too thick, the gap between the base and the conductor becomes too large, and the inductance component is reduced.

The shape of the base is not particularly limited, and the cross section may be a rectangle, a square, or a circle and an external shape may be a rectangular parallelepiped, a circular column, etc. In order to realize a stable mounting, the shape is preferably a rectangular parallelepiped. In the case of the rectangular parallelepiped, it is preferable to provide a chamfer on a portion of the corner positioned in a direction perpendicular to the longitudinal direction. By providing the chamfer, it is possible to reduce the tendency of leakage of the magnetic flux when, for example, a magnetic base is used as the base, and to prevent problems such as chipping. The method of chamfer may be a method to cut the corner portion in a straight line or may be a method to form a curvature. The width of the chamfer (a length lost in the side surface of the magnetic base by the chamfer portion) is desirably 0.2 mm or greater, in order to achieve a substantial advantage. On the other hand, when the chamfer is large, stable mounting cannot be achieved even with a rectangular parallelepiped shape. Therefore, the width is desirably 1 mm or less (⅓ or less of the width or height of the base). The lengths of the bases of the antenna elements do not need to be the same, but with bases of same lengths, the manufacturing steps can be simplified.

When a magnetic material is used for the base, if the size of the base including the length, width, and height is increased, the resonance frequency is reduced. For example, in order to use the base in the quad-band portable phone of the GSM band (810 MHz-960 MHz) and DCS/PCS and UMTS bands (1710 MHz-2170 MHz), the size of the base is preferably 5 mm in the width and 5 mm or less in the height in consideration of the antenna mounting space of the housing, and the total of the lengths along the longitudinal direction when the base is divided is desirably 60 mm or less. More preferably, the total of the lengths of the bases is about 30 mm, the width is in the range of 2 mm-4 mm, and the height is in the range of 2 mm-4 mm.

In addition, although the cross sectional shape of the conductor penetrating through the base is not particularly limited, the cross sectional shape is, for example, a circle, a square, a rectangle, or the like. That is, as the conductor, a line-shaped conductor (wire) or a film-shaped conductor (ribbon) may be used. For example, when a magnetic base is used for the base, the cross sectional shape of the conductor and the cross sectional shape of the base may be set approximately similar to each other, and the thickness of the magnetic material coaxially surrounding the outer periphery of the conductor may be set to a constant. With this structure, a magnetic path having a high uniformity is formed, and, thus, such a structure is desirable. The cross section described herein refers to a cross section of the base perpendicular to the longitudinal direction of the base. For example, when a line-shaped conductor penetrates through the longitudinal direction of the base having a rectangular parallelepiped shape or a circular column shape, the cross section perpendicular to the longitudinal direction is a cross section in which the base coaxially surrounds the outer periphery of the conductor. When the base has a curved shape such as an arc shape (arch shape) in the longitudinal direction, the cross section is a cross section perpendicular to the circumferential direction of the arc, that is, a cross section cutting the arc in the radial direction. In this case also, the cross section is a cross section in which the base coaxially surrounds the outer periphery of the conductor.

Moreover, although the outer shape of the conductor portion is not particularly limited, the outer shape is desirably a rectangle, a square, etc. when the conductor portion has a plate shape. For example, when a plate-shaped conductor having a rectangular shape is used in a standing manner, the conductor portion may be bent corresponding to the board space and the shape of the housing to form an approximate L shape, or, alternatively, the shape of the conductor portion having the plate shape may be configured such that the approximate center portion is formed in a square bracket shape or an arc shape (arch shape) corresponding to the board space or the shape of the housing.

Furthermore, by using a material form which allows easy processing such as a line shape, a film shape, and a lattice shape as the form of the conductor portion, it is possible to conform with a housing having a complex shape, because such a material form is more flexible compared to a plate shape. A film shape primarily refers to a metal conductive film having a thickness of about 10 μm, which is formed on the board by a printing unit. As the material, Cu, Ag, etc. is used. A lattice shape refers to a shape in which the outer appearance shape is a plate shape, but with a plurality of holes having a size of few tens of micrometers formed on the plate-shaped surface, or a shape formed by connecting line-shaped conductors having a diameter of few tens of micrometers through soldering or the like in a mesh shape. As the material, Cu, Ag, etc. is used. In the case of FIGS. 5 and 6, the conductor portion 100 and the conductor portion 200 may be set as plate-shaped, film-shaped, lattice-shaped, or line-shaped conductor portions in which the total length of the conductor portion 100 and the conductor portion 200 is longer than the length of the first antenna element 4 or the total length of the first antenna element 4 and the fourth antenna element 2. With such a structure, it is possible to handle digital terrestrial television broadcasting band having a lower frequency and a wider band than the GSM band. One side of the conductor portion is desirably close to and parallel to the longitudinal direction of the base.

When the conductor portions 100 and 200 are formed as plate-shaped, film-shaped, or lattice shaped conductors and in an approximate L-shape, for example, as in FIG. 3, the sizes are desirably set so that one side is in the range of 6 mm-10 mm, another side is in the range of 10 mm-30 mm, a width in the vertical direction (height) is in the range of 0.4 mm-10 mm, and a thickness is in the range of 0.6 mm-1 mm. When the conductor portion is formed with a conductive line, the diameter is desirably about 0.4 mm-0.8 mm. The pattern width is desirably about 1 mm. In this case, the connecting conductor is connected to a partway on the conductor portion having the approximate L-shape, and the antenna is formed in an equivalent shape of an approximate T-shape, and the second antenna element 1 and the third antenna element 21 are formed. Each of the ends projecting from the base is connected to the respective connecting conductor. When the side of the conductor portion opposing the ground portion is close to the ground portion, a parasitic capacity which does not contribute to radiation is increased due to capacitance coupling, and the radiation efficiency of the antenna is reduced. In consideration of this, the distance W between one side of each of the conductor portions 100 and 200 and the ground portion end 40a on the main circuit board is preferably maintained at 6 mm-10 mm in order to reduce the influence by the capacitance coupling with the transmission/reception circuit and the ground. The distance between the ends of the conductor portions 100 and the 200 closest to the ground portion and the ground portion end 40a is preferably close and is approximately 0.2 mm-1 mm. With the placement of the end surfaces of the conductor portion opposing and close to the ground portion, the change of the frequency when the distance is increased or decreased is small, and, thus, such a configuration is advantageous in fine adjustment of the resonance frequency.

A structure in which a straight line-shaped conductor penetrates through the base as shown in FIG. 9A-9C will now be described in more detail. Such a structure can be manufactured by forming the base and then penetrating the base with the conductor. For example, Fe₂O₃, BaO, and CoO which are main compositions of the base are set in a certain molar ratio, 0.6 weight part of CuO is added to the main compositions, and the resulting compositions are mixed in a wet ball mill with the water as a medium. Next, the mixture powder is dried and calcinated. The calcinated powder is crushed in a wet ball mill. Water, a binder, a lubricant, and a plasticizer are added to the obtained crushed powder, and extrusion is executed such that the base is hollow to allow conductor to penetrate through the center portion. The resulting structure is sintered and a sintered structure having a rectangular parallelepiped shape is obtained. A conductor is inserted into the hollow portion of the obtained sintered structure, and the structure is completed.

As another method of manufacturing, the base and the conductor may be integrally formed. For example, when the base is constructed with a magnetic material, the method as disclosed in the Document 1, that is, a method of compressing and molding in a state in which the conductive line is placed in a powder of the magnetic material and sintering the powder, may be employed. As a method of integrally forming the base and the conductor, it is also possible to employ a layering process in which green sheets are layered. A mixture of the magnetic material powder, a binder, and a plasticizer is sheet-molded through a doctor blade method or the like to obtain a green sheet, and the green sheets are layered to obtain a layered structure. A conductor paste such as Ag can be printed in a straight line on the green sheet, to obtain a magnetic base through which a conductor penetrates.

Although the cross sectional shape of the through hole of the base is not particularly limited, a shape such as, for example, a circle, a quadrangle, and a rectangle may be used. In order to facilitate insertion of the conductor and to reduce a gap between the base and the conductor, the cross sectional shape of the through hole may be set to a shape similar to the cross sectional shape of the conductor. There may be a space between the base and the conductor, but, because the presence of the space results in a reduction of the inductance component, the space is desirably sufficiently small compared to the thickness of the base. More specifically, the space is preferably 50 μm or less on one side. Preferably, the cross sectional shape of the through hole and the cross sectional shape of the conductor are approximately the same within a range to allow insertion of the conductor. This point does not depend on the formation method of the through hole.

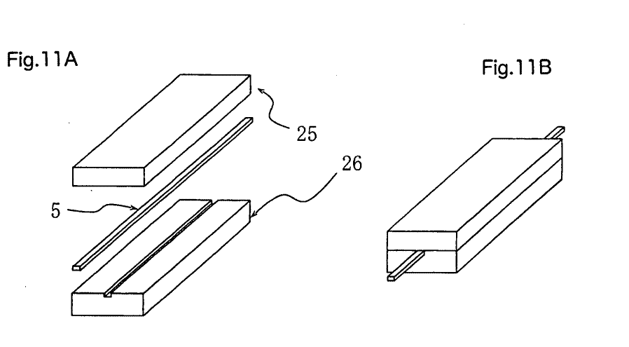

FIG. 11 shows an example in which the magnetic base and the conductor are formed as separate structures to realize a configuration where the base in the structure in which the straight line-shaped conductor penetrates through the base as shown in FIG. 9A-9C is constructed with a magnetic base. The example of FIG. 11 is a preferred embodiment in which the magnetic base having the rectangular parallelepiped shape is formed with a plurality of members and the through hole is formed by the plurality of members. FIG. 11(a) shows a structure where the magnetic base comprises a magnetic member 26 on which a groove is formed for insertion of the conductor, a conductor 5, and a magnetic member 25 to be affixed with the magnetic member 26 with the groove therebetween, and shows a state before the antenna element is constructed with the magnetic base. FIG. 11(b) is a diagram showing a state in which the conductor 5 is inserted into the groove of the magnetic member 26, the magnetic member 25 is affixed and fixed, and the antenna element is formed. The conductor 5 may be inserted into the formed through hole after the magnetic member 26 and the magnetic member 25 are affixed. In either case, the through hole is formed by affixing the magnetic member 26 and the magnetic member 25. The groove may be formed with a high precision with the use of, for example, a dicing process. In the example of FIG. 11, because the base is assembled by a simple process of groove machining and affixing of members, the through hole can be very easily formed. The cross sectional shape of the groove is set corresponding to the cross sectional shape of the conductor to enable insertion of the conductor. In other words, the depth of the groove is set so that the conductor does not extend off the upper surface of the groove. Although in the example of FIG. 11, the groove is provided on one of the magnetic members, alternatively, the through hole may be formed by providing the groove on both magnetic members and affixing the magnetic members with the grooves opposing each other. In this case, the inserted conductor also functions to position the magnetic members.

As another preferred embodiment of a structure where the magnetic base is constructed from a plurality of members and the through hole is constructed with the plurality of members, the following structure may be employed. Specifically, the magnetic base has a rectangular parallelepiped shape and is constructed by sandwiching two thin-plate-shaped magnetic members by another magnetic member. Both of the magnetic members have a rectangular parallelepiped shape. The through hole is formed by the two thin-plate-shaped magnetic members having a predetermined distance between each other, and the distance between and the thicknesses of the two magnetic members determine the shape and size of the through hole. Because such a structure does not require a groove machining and the magnetic member can be manufactured with simple processing, such a structure is suitable for a simple manufacturing of the chip antenna.

A cramp or the like may be used to fix the magnetic base and the conductor or the magnetic member and the magnetic member. However, in order to reliably fix the members, it is preferable to adhere the members. For example, the adhesion of the magnetic member and the conductor can be achieved by applying an adhesive in the space between the magnetic base and the conductor and hardening the adhesive. The adhesion of the magnetic members can be achieved by applying the adhesive and hardening on the affixing surface. Because an increase in the thickness of the adhesive results in a larger magnetic gap, the thickness of the adhesive is preferably 50 μm or less, and, more preferably, is 10 μm or less. In order to inhibit formation of a magnetic gap, the adhesive may be applied and hardened in sections other than the affixing surface. For example, the adhesive may be applied at the side surface stretching over the affixing portion of the magnetic members.

As the adhesive, a thermosetting resin, a ultra-violet curing resin, or an inorganic adhesive maybe used. In the resin, a magnetic filler such as an oxide magnetic material may be introduced. In consideration of the case of fixing of the chip antenna by solder, the adhesive desirably has a high thermal endurance. In particular, when a reflow process is applied in which the entire chip antenna is heated, the adhesive desirably has a thermal endurance of approximately 300° C. When the space between the magnetic base and the conductor is small and the movement of the conductor provided in the through hole of the magnetic base is sufficiently constrained by the magnetic base, there is no need to provide the fixing structure between the magnetic base and the conductor.

As the magnetic base, materials such as a Spinel type ferrite such as a Ni—Zn-based ferrite and a Li-based ferrite, a hexagonal ferrite such as Z-type and Y-type which are called planar types, and a composite material including these ferrite materials may be used. A desirable material is a sintered structure of a ferrite, and the use of the Y-type ferrite is particularly desirable. Because the sintered structure of ferrite has a high volume resistivity, the sintered structure of ferrite is advantageous for insulation from the conductor. When the sintered structure of ferrite having a high volume resistivity is used, the insulating cover from the conductor is not required.

In general, when a ferrite is used in the antenna, the loss of the antenna is proportional to a magnetic loss tan δ× magnetic permeability μ. The magnetic loss tan δ is preferably very small, and the magnetic permeability μ is preferably about 2-6. Among the Y-type ferrites, the Y-type ferrite of Table 1 to be descried later is preferable for an antenna element, in a portable phone, of a quad-band including the GSM band (810 MHz-960 MHz) and DCS/PCS and UMTS bands (1710 MHz-2170 MHz), because the magnetic permeability μ is maintained at about 2-6 to a high frequency of 3 GHz or greater and the magnetic loss tan δ is small in the frequency band to 3 GHz. In this case, the sintered structure of the Y-type ferrite may be used as the magnetic base. The sintered structure of Y-type ferrite is not limited to a single phase of the Y type, and may include other phases such as the Z type or W type. When the sintered structure has a sufficient precision in size as the magnetic member after the sintering, there is no need for processing, but for the affixing surface, a grinding process is desirably applied, to secure a degree of flatness.

A structure with the initial magnetic permeability of the Y type ferrite at 1 GHz set at 2 or greater and the loss coefficient set at 0.1 or less, more preferably, 0.05 or less, is advantageous in realizing an antenna element having a wide band and a high gain. If the initial magnetic permeability is too low, it becomes difficult to widen the band. On the other hand, if the loss coefficient, that is, the magnetic loss, is increased, the gain of the chip antenna is reduced. In order to achieve an average gain of −5 dBi or greater as the antenna element, the loss coefficient is desirably 0.05 or less. By reducing the loss coefficient to 0.03 or less, an antenna element having a particularly high gain can be realized.

As described, in the structure of the magnetic base in the preferred embodiment of the present invention, a stray capacity tends to not be formed, and the increase in the internal loss of the antenna element is inhibited even when the relative dielectric constant is increased by a certain degree. From the viewpoint of the loss, the dielectric constant is desirably small. In the structure of the magnetic base of the embodiment, the internal loss of the antenna is not significantly affected by the relative dielectric constant; that is, the internal loss is insensitive to the relative dielectric constant. Therefore, a dielectric material having a large dielectric constant can be used for the base in order to inhibit variation in the resonance frequency. In this case, the relative dielectric constant is desirably 4 or greater, and more desirably, 6 or greater.

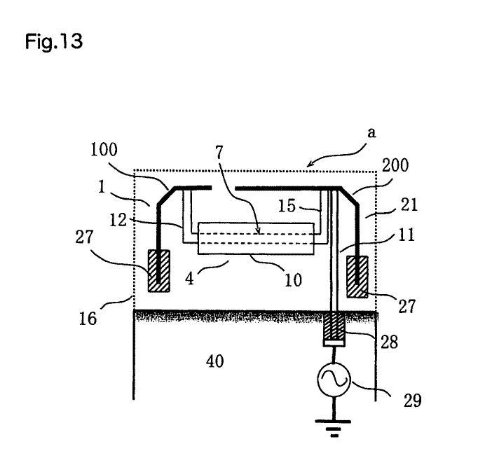

Next, a connection and fixing method of the antenna element will be described with reference to FIG. 13. When the first antenna element 4 of FIG. 2 is used, the connection method is such that the first end of the conductor which is on the non-power supply side and projecting from the magnetic base 10 is connected via the connecting conductor 12 to the conductor portion 200, the second end which is on the power supply side is connected via the connecting conductor 15 to the conductor portion 100, and the power supply line 11 connected to the conductor portion 100 is connected to a power supply electrode 28 and via the power supply electrode 28 further to the transmission/reception circuit or the like 29 (not shown), and the antenna apparatus is formed. These connections are achieved by joining with solder or the like.

In a specific fixing method of the antenna element, the conductors are connected through solder or the like as described above and the conductors and base are fixed on the board. When the conductor portions 100 and 200 are plate-shaped conductor portions, a pin-shaped projection is formed at an edge portion of the conductor portion which contacts the board surface, and the projection is fixed through soldering to a fixing electrode 27 provided on a board 16 so that the conductor portion stands perpendicular to the board. When the conductor portions 100 and 200 are conductor portions formed by line-shaped conductive lines also, a pin-shaped projection may be connected to the conductive line, and the projection may be fixed on the fixing electrode provided on the board 16 through soldering so that the conductor portion stands perpendicular to the board. The first antenna element 4 comprising the base 10 and the conductor 7 has the ends connected via the connecting conductor 12 to the conductor portion 200 and via the connecting conductor 15 to the conductor portion 100 through soldering. The bottom surface is joined with the board using an adhesive or the like, so that the structure is fixed.

The second end and the first end of the conductor 7 of the first antenna element 4 connected to the conductor portions 100 and 200 is not necessarily be fixed on the electrode or the like on the board, but, in order to achieve stable mounting and adjustment of the resonance frequency, it is desirable that the side to be connected to the conductor portion is also temporarily fixed on the electrode on the board or the like and connected to the conductor portion. For example, in the configurations shown in FIGS. 1-8, the connection may be achieved in a manner similar to the configuration shown in FIG. 10A and 10B. In addition, the first antenna element 4 is placed so that the longitudinal direction of the conductor 7, that is, the longitudinal direction of the magnetic base 10, is parallel to the plane of the board, to enable low-height and stable mounting. This point is similar to the antenna apparatuses of the other preferred aspects of the embodiment to be described below.

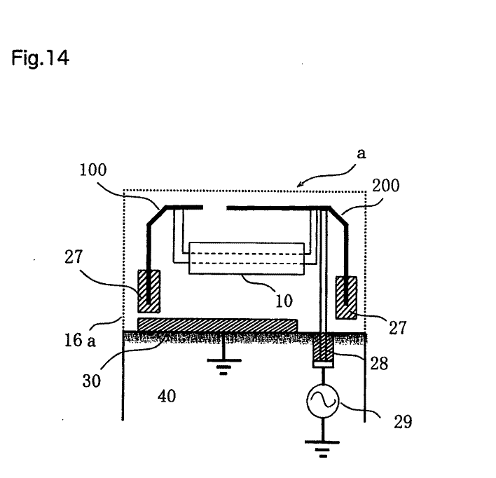

When the conductor portions 100 and 200 are conductive films fixed by an adhesive or the like along an internal surface of the housing or a conductor pattern of a metal conductive film formed through printing or the like on a separate board which is an auxiliary board, the connecting conductors 12 and 15 can be joined to the conductor portions 100 and 200 through soldering. The connections between the conductor 7 projecting from the magnetic base and the conductor portions 100 and 200 may be achieved by a direct connection through the connecting conductors 12 and 15. The antenna apparatus of the embodiment may be used in any of the forms of a reception antenna, a transmission antenna, and a transmission/reception antenna. Alternatively, as shown in FIG. 14, the antenna a may be mounted on an auxiliary board 16a and separated from the main circuit. In this case, with the increase in the distance between the ground portion 40 on the main circuit board and the antenna a, the capacitance coupling with the ground portion is reduced, and the gain and the bandwidth are improved, and, furthermore, there is an advantage that reception, at the antenna, of noise radiated from the main circuit is reduced, and the reception sensitivity of the wireless device can be improved.

Next, an adjustment method of the resonance frequency of the antenna apparatus will be described. In order to determine the band which is used in the antenna of the embodiment, first, a center frequency f₀ must be determined. For this purpose, the specification of the conductor portion must be determined. A material for the conductor portion is first selected, and a length, a width, a thickness, etc. are roughly determined in consideration of the constraint condition of the space in the housing and the resonance frequency of the used frequency band. When the base is formed with a magnetic base, a magnetic base which is selected based on the magnetic permeability μ desirable for the target frequency band and the size is equipped in advance, and the length of the conductor portion is adjusted and determined to match the center frequency f₀ of the target frequency band.

More specifically, in the adjustment of the magnetic base, the magnetic permeability μ is determined by selecting the material and the center frequency f₀ of the antenna is determined by equipping and connecting the conductor portion. Because the resonance frequency is reduced as the size of the magnetic base is increased, the width and the height of the magnetic base are first determined, and then, the approximate length of the overall magnetic base is determined to a slightly larger value. When the width of the housing cannot be widened because of the constraint in the shape or the like, the magnetic base is divided and the length of the overall base is determined by the total length. Next, a length of the conductor portion is determined. First, a low frequency band is adjusted by adjusting the length of the conductor portion connected to the magnetic base on the power supply side. In order to secure a wide band in the low frequency band, the length is adjusted by setting lengths of the plurality of conductor portions extending from base points at connection points between the connecting conductors and the conductor portions to slightly differ from each other, to have a plurality of resonance points. Next, the high frequency band is adjusted by adjusting the length of the conductor portion connected to the magnetic base on the non-power supply side. In order to secure a wide band at the high frequency band in this process, the length is adjusted by setting the lengths of the plurality of conductor portions extending from base points at the connection points between the connecting conductors and the conductor portions to slightly differ from each other, to have a plurality of resonance points. Finally, the lengths of the conductor portions and the distances between the conductor portions and the ground are finely adjusted so that a balanced gain and a balanced VSWR are achieved over the entire band.

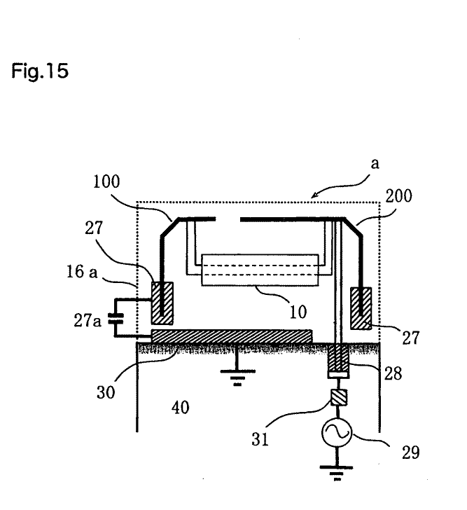

Next, another adjustment method of the resonance frequency of the antenna apparatus will be described with reference to FIGS. 14 and 15. In FIGS. 14 and 15, because the antenna apparatus is mounted on the auxiliary board 16a, a grounding electrode 30 is provided. When the antenna apparatus is mounted on the board 16 on which the main circuit components other than the antenna apparatus are also mounted, the ground may be provided at the ground portion 40 of the board 16. In the antenna apparatus of FIG. 14, the base 10 is placed between the conductor portions 100 and 200 and the grounding electrode 30, and flat portions of the conductor portions 100 and 200 are placed perpendicular to the surface of the grounding electrode 30. With this placement, a structure can be achieved in which the distance is secured and the stray capacity is significantly inhibited. When the capacity component (between the fixing electrode 27 and the grounding electrode 30) is insufficient with respect to a desired antenna characteristic, a capacity component 27a is added by a method shown in FIG. 15, to adjust the antenna characteristic. As a specific example of adjusting the resonance frequency of the antenna, methods may be employed such as connection and switching of at least one capacitor and a switch between the fixing electrode 27 and the grounding electrode 30, provision of a matching circuit 31 between the power supply electrode 28 and the transmission/reception circuit 29, and connection of a variable-capacitance diode (varactor diode) and adjustment to the predetermined resonance frequency while changing the electrostatic capacity with an applied voltage. With these methods, the capacity component can be more easily adjusted compared to the method of adjusting the capacity component of the chip antenna itself.

By constructing an antenna apparatus with the antenna of the embodiment, the operation frequency band of the antenna apparatus can be widened. The frequency bands used in a portable phone are GSM band (810 MHz-960 MHz) and DCS/PCS and UMTS bands (1710 MHz-2170 MHz), but the frequency bandwidths are 150 MHz and 460 MHz and the GSM band and the DCS/PCS and UMTS bands are separated by approximately 1000 MHz.

In general, when the used frequency bands are separated by few hundreds of MHz, a plurality of antenna apparatuses must be used. In this case, the mounting area is increased and the mounting space is enlarged. According to the embodiment, because the connecting conductors are connected to a partway on the conductor portions, by setting the lengths, corresponding to approximately λ/4 of the used frequency in the conductor portions, extending from a base point at the connection point and along two directions to slightly differ from each other, it is possible to realize resonances at a plurality of frequencies f1 and f2 as shown in, for example, FIG. 21. As a result, the frequency bands can be widened. By taking advantage of this effect, the resonance at the GSM band can be achieved with the base and the conductor portion at the tip on the non-power supply side of the base. In addition, the resonance at the DCS/PCS and UMS bands can be achieved by the base and the conductor portion of the base on the power supply side. Because a multiplex resonance occurs at the section where the base and the conductor portion on the power supply side of the base oppose each other, a low VSWR and a high gain can be obtained, in particular, over the DCS/PCS and UMTS bands which are high frequency bands and wide bands. As a result, only one antenna apparatus is required even when frequency bands each having a wide operation frequency band and which are separated from each other by few hundreds of MHz are to be realized in one portable phone. With the use of the antenna apparatus having the bandwidth as described above, it is possible to cover the frequency bands including the GSM band and the DCS/PCS and UMTS bands.

A required average gain of the antenna apparatus is desirably −5 dBi or greater, and a gain of −3 dBi or greater can be secured according to the embodiment in each of the separated frequency bands as described above. Similarly, a required VSWR is desirably 4 or less, and a VSWR of 3.5 or less can be secured according to the embodiment in each of the separated frequency bands as described above.

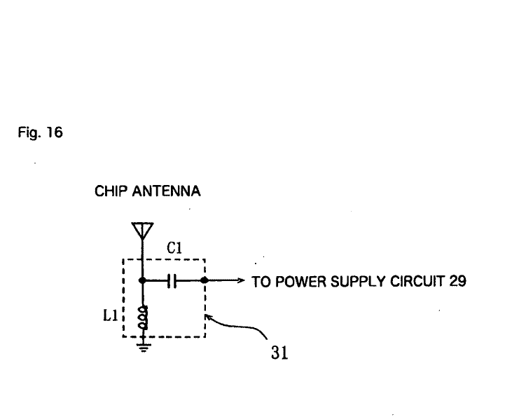

The antenna of the preferred embodiment according to the present invention is a combination of a dielectric chip antenna or a magnetic material chip antenna and a plurality of conductor portions, and can cover a wide frequency band. In order to achieve an antenna with a high gain over a wider band, it is possible to provide a matching circuit 31 which adjusts the resonance frequency of the antenna apparatus between the antenna element and the transmission/reception circuit as shown in FIG. 16. The matching circuit 31 as shown in, for example, FIG. 16 is used. In the example structure of FIG. 16, a matching circuit is formed with a capacitor C1 and an inductor L1. The conductor of the antenna element is connected to a second end of the capacitor C1 and a second end of the inductor L1, a first end of the inductor L1 is grounded, and a first end of the capacitor C1 is connected to the transmission/reception circuit 29. Because the antenna of the embodiment can cover a wide frequency band by itself, the matching circuit may be of a simple structure, and the occupied space can be reduced.

The antenna and the antenna apparatus which is formed using the antenna are used in a communication device. For example, the antenna and the antenna apparatus can be used in communication devices such as portable phones, wireless LANs, personal computers, digital terrestrial television broadcasting related devices, etc., and contribute to widening of the bands in the communications using these devices. In particular, with the use of the antenna or the antenna apparatus using the antenna of the embodiment, the band can be widened, and the increase in the mounting area and the mounting space can be inhibited, and, thus, the antenna can be used in a portable phone or a portable terminal which transmits and receives the digital terrestrial television broadcasting.

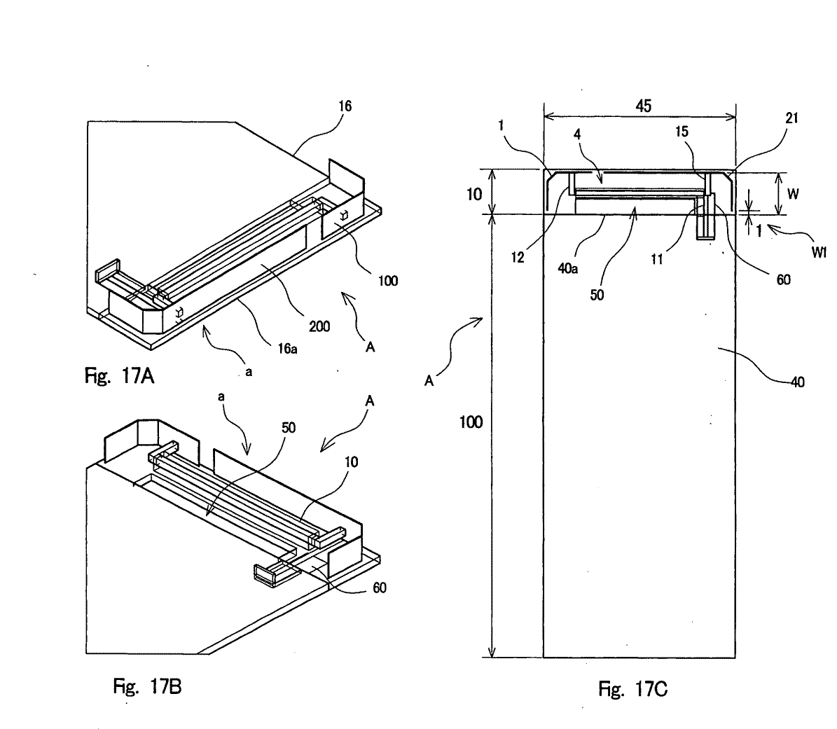

FIG. 17A-17C show an example of the use in a portable phone as a communication device. A position of the antenna a which is built in is at an upper portion of the drawing. In a portable phone 33, the antenna a is attached to a board. One side of each of the first antenna element 4 and the second antenna element 1 comprising the conductor portion 100 which form the antenna a is placed parallel to a longitudinal direction of one side of the third antenna element 21 comprising the conductor portion 200. The primary portions of the conductor portion 100 and the conductor portion 200 are placed along the inside of a tip of the housing of the portable phone 33 in order to achieve a mounting with a small spatial loss at the tip section of the portable phone 33. In this example configuration, an auxiliary board 16a having a recessed shape is placed between the board 10 and the ground portion 40 of the board 16, with the recessed portion contacting one side of the board 16 such that the space 50 has a hollow quadrangle shape viewed from the surface of the board 16.

When the antenna a is to be directly provided on the board 16 without the auxiliary board 16a, the space (opening) 50 may be provided in the hollow quadrangle shape below the base 10. With the presence of the space 50, the dielectric constant is reduced, the Q value is reduced, the electrostatic capacitance therebetween is reduced, and the current in the opposite direction (which occurs near the ground portion 40a) which cancels the resonant current occurring in the antenna a is reduced. As a result, advantages such as a wider band and a higher gain can be obtained. By providing a conductor 60 comprising Cu, Ag, or the like opposing the power supply line 11 on a backside of the board 16 or between layers in the board 16, it is possible to achieve a superior impedance matching and widen the bandwidth, and, as a result, a high gain can be realized over the entire band and the antenna performance can be improved.

The technical content, such as the placement of the antenna, of the communication device of the present invention described above is not limited to a portable phone, and may be applied to an antenna apparatus of a portable communication device having the antenna mounted on the auxiliary board.

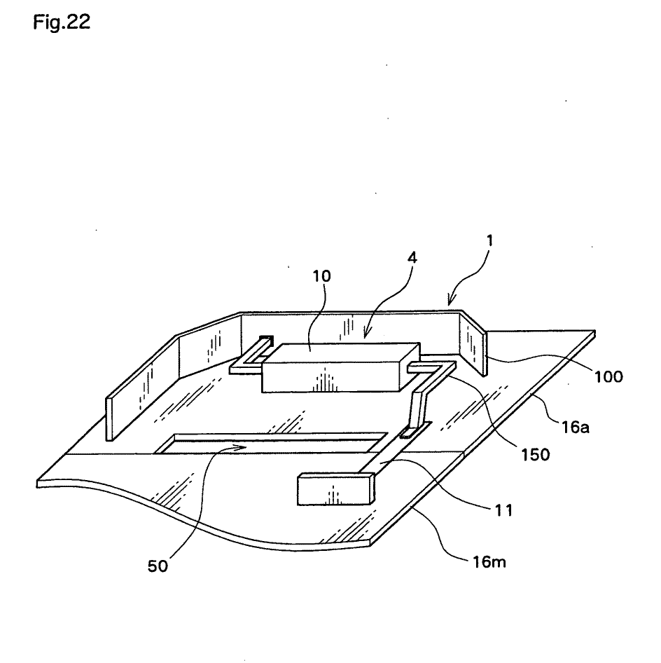

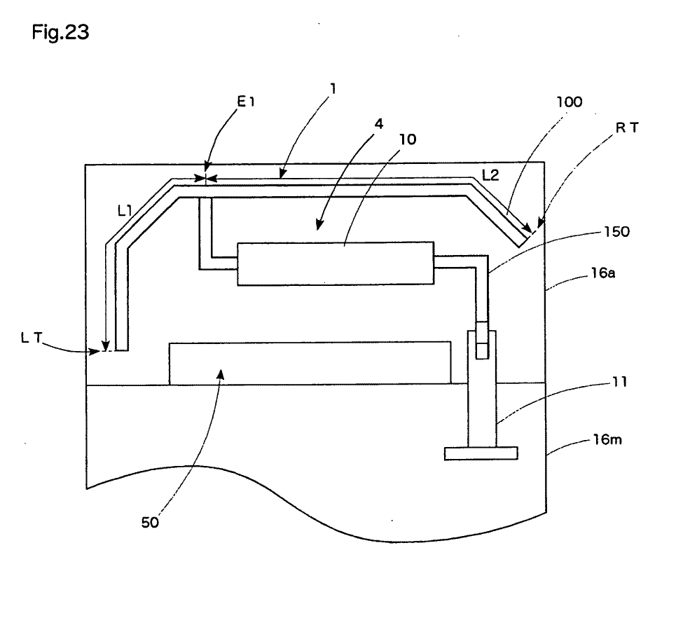

FIG. 22 is a perspective view of an antenna according to a preferred embodiment of the present invention. FIG. 23 shows a plan view of the antenna in the preferred embodiment. The antenna is provided on an antenna board (auxiliary board 16a) which is, provided on approximately the same plane as a main board 16m, has a square bracket shape, and forms a space 50 with the main board 16m. On the side of the main board 16m, a ground pattern is formed to a boundary portion with the auxiliary board 16a. The space 50 is not a necessary structure, but the formation of the space 50 can reduce the Q value when the Q value of the antenna is high.

In FIG. 22, the power supply line 11 extends from the main board 16m to the auxiliary board 16a. In addition, a first conductor 150 penetrates the antenna base 10 (similar to the structure of FIG. 9A-9C), and the ends of the first conductor 150 are exposed to the outside of the antenna base 10. A first end of the first conductor 150 is connected to the power supply line 11 and a second end of the first conductor 150 is electrically connected to a plate-shaped second conductor 100.

As described above, the antenna base 10 is a magnetic material chip or a dielectric chip, and a portion of the first conductor 150 in the antenna base 10 functions as the first antenna element 4 along with the antenna base 10.

In the example configuration of FIG. 22, the conductor portion 100 which is the second conductor is set as a plate-shaped conductor which is provided approximately perpendicular to the ground pattern surface (which is placed in parallel to the plane of the board) of the board 16, in order to prevent an increase in the stray capacity due to an increase in an opposing area between the conductor portion 100 and the ground pattern. The conductor portion 100 is bent along the periphery of the auxiliary board 16a in a manner to form an obtuse angle at a bent section. Here, the conductor portion 100 is bent to form a polygon in a plan view, but the bending is not limited to such a configuration and the conductor portion 100 may alternatively be curved in an arc shape.

As shown in FIG. 23, an end of the first conductor 150 is electrically connected at a point E1 which is distanced from the ends LT and RT of the conductor portion 100 along the longitudinal direction by predetermined lengths L1 and L2, respectively (the conductor length is L1 between LT and E1 and the conductor length is L2 between RT and E1). The conductor portion 100 is supplied with power from the power supply line 11 via the first conductor 150, and functions as the second antenna element 1.

In this manner, by placing the conductor portion 100 along the outer periphery of the auxiliary board 16a surrounding the first antenna element 4, the second antenna element 1 can correspond to a relatively low frequency band, for example, the digital terrestrial television broadcasting band having a lower frequency and a wider band than the GSM band.

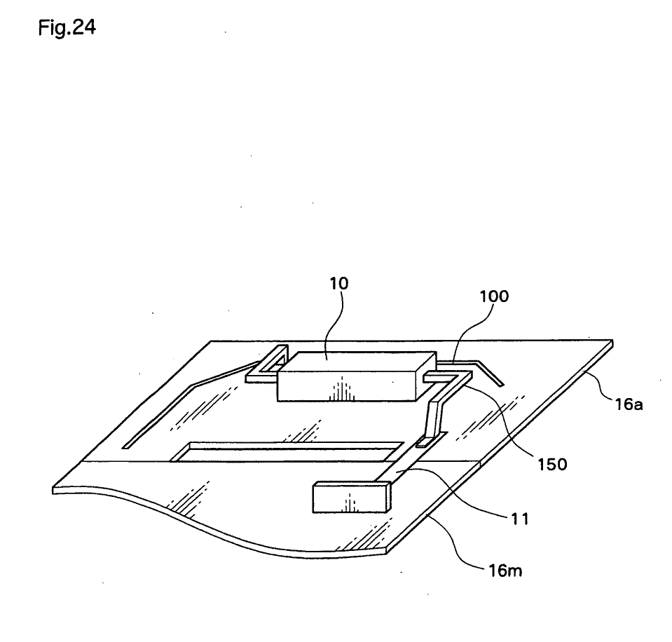

In the above description, the conductor portion 100 is described to be a plate-shaped conductor, but the present embodiment is not limited to such a configuration, and the conductor portion 100 may alternatively be formed in the surface of the board 16a with an electrical wire or a metal film, as shown in FIG. 24. Alternatively, the conductor portion 100 may be a conductor line path pattern formed on the board 16. In either case, the first conductor 150 is electrically connected to a point E1 which is at a position distanced from the ends LT and RT by predetermined lengths L1 and L2.

For example, in the digital terrestrial television broadcasting band having a wide band, the lengths L1 and L2 may be set slightly differing from each other, to achieve two resonance frequencies corresponding to the conductor lengths L1 and L2 which differ from each other, so that the band can be covered with a less reduction in the gain over the entire broadcasting band.

Moreover, in the above description, the conductor portion 100 is described to receive the power via the first conductor 150, but the present invention is not limited to such a configuration, and power may be supplied from the power supply line 11 via a connecting conductor which is different from the first conductor 150. In this case, the connecting conductor is electrically connected to a point at a position distanced from the ends LT and RT of the conductor portion 100 by conductor lengths L1 and L2. When power is supplied to the conductor portion 100 using the connecting conductor in this manner, a first end of the first conductor 150 may be connected to the connecting conductor and receive power or may be connected to the conductor portion 100 and receive power.

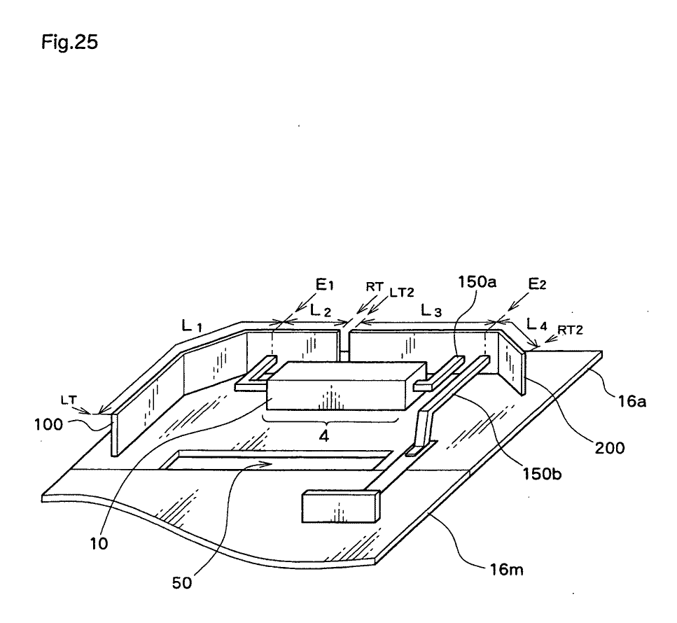

FIG. 25 shows another example of an antenna of a preferred embodiment according to the present invention. In the antenna of the example configuration of FIG. 25, the conductor portion 100 which is a second conductor and the conductor portion 200 which is a third conductor are placed in a manner to surround the first antenna element 4. The conductor portions 100 and 200 may also be set as a plate-shaped conductor which is placed approximately perpendicular to the ground pattern surface (which is placed parallel to the plane of the board) of the board 16m.

Here, a first end of the connecting conductor 150b is connected to a point E2 which is at a position distanced from the ends LT2 and RT2 of the conductor portion 200 by predetermined lengths L3 and L4. The second end of the connecting conductor 150b is connected to the power supply line 11, and the conductor 200 receives power from the power supply line 11 via the connecting conductor 150b.

The portions of the conductor extending from the power supply point E1 by the lengths L1 and L2 may be resonated in the GSM band, the portions of the conductor extending from the power supply point E2 by the length L3 may be resonated in the DCS/PCS band, and the portion of the conductor with the length L4 may be resonated in the UMTS band, so that the antenna corresponds to the quad-band. When resonance of a particular frequency is to be achieved or when the GSM band is not required, L1 or L2 may be set to 0, and the conductor portion 100 may be provided extending in a straight line from the first end of the first conductor 150a. In this case, the conductor portion 100 is provided at a position corresponding to the conductor portion 100′ shown by a dotted line in FIG. 7. Similarly, when the DCS/PCS band is not desired, L3 may be set to 0, and, when UMTS band is not required, L4 may be set to 0. In both cases where L3=0 and L4=0, the conductor portion 200 may be provided in a manner similar to that shown in FIG. 7.

In addition, a first end of the first conductor 150a is connected to the conductor portion 200. The first conductor 150a penetrates through the antenna base 10, and both ends expose to the outside of the antenna base 10. The first conductor 150a is electrically connected to a point E1 at a position distanced from the ends LT and RT of the conductor portion 100 by predetermined lengths L1 and L2.

In the example configuration of FIG. 25 also, the conductor portions 100 and 200 do not need to be plate-shaped conductors, and may be formed with an electrical wire or a metal film. In addition, the conductor portions may be conductor line path patterns formed on the board 16. The first conductor 150a may be connected to the connecting conductor 150b instead of the conductor portion 200. In this case, the first conductor 150a receives power via the connecting conductor 150b.

In the antenna of the present embodiment, unlike the dielectric chip antenna and the magnetic material chip antenna having a helical electrode, no conductor is wound around the antenna base 10. Thus, the stray capacity between the lines tends to be reduced, and the structure is advantageous in enlarging the band. In addition, the antenna base 10 is distanced from one side of each of the conductor portions 100 and 200 and the ends of the conductor portions 100 and 200 are distanced from the ground pattern of the main board 16m. Therefore, a radiation resistance between the ground of the main board 16m and the conductor portion 100 or 200 is increased and the radiation efficiency is improved.

In addition, in the present embodiment, for both conductor portions 100 and 200, power is supplied to positions distanced from the ends by predetermined conductor lengths. Therefore, by setting L1 to not equal to L2 (L1≠L2), it is possible to set the distances corresponding to λ/4 of the corresponding frequencies, and resonances at two frequencies which differ from each other may be achieved by the conductor portions. With this structure, a frequency band in which the voltage standing wave ratio (VSWR) is low and the gain is improved can be widened. In other words, with these structures, superior antenna characteristic can be obtained for a wide band.

The shapes of the conductor portions 100 and 200 may be set to an approximate U shape, an approximate reversed V shape, or an approximate Y shape, corresponding to the auxiliary board 16a and the shape of the housing which stores the auxiliary board 16a.

A signal processing circuit or a transmission/reception circuit is connected to the board 16m. The signal processing circuit receives, for example, input of data to be transmitted, encodes the data, and outputs the encoded data to the transmission/reception circuit. The transmission/reception circuit modulates the encoded data, outputs the modulated data as a high frequency signal via the power supply line 11, and radiates the data from the antenna (the first antenna element 4, the second antenna element 1, etc.) mounted on the auxiliary board 16a.

The transmission/reception circuit also receives, via the power supply line 11, a signal reaching the antenna, demodulates the signal, and outputs the demodulated signal to the signal processing circuit. The signal processing circuit decodes the encoded data included in the demodulated signal, and outputs the data obtained by decoding.

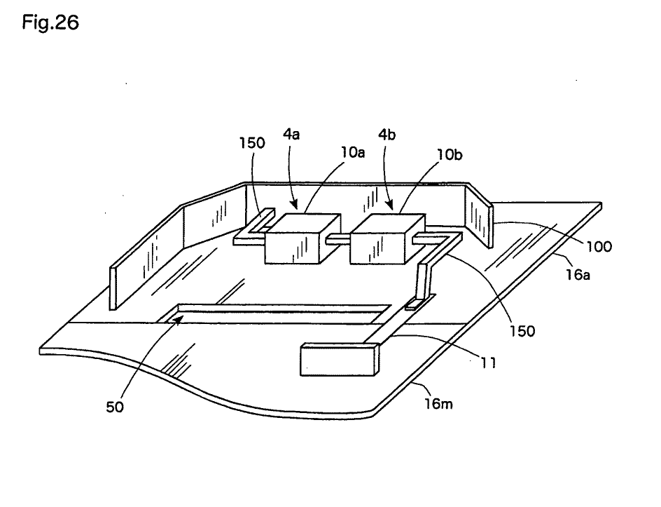

In the antenna of the present embodiment, as shown in FIG. 26, the first conductor 150 may penetrate through a plurality of antenna bases 10a and 10b. In this case, the antenna bases 10a and 10b are placed in a distanced manner. With such a structure, the portion of the first conductor 150 penetrating through the antenna base 10a can function as the antenna element along with the antenna base 10a, and, similarly, the portion of the first conductor 150 penetrating through the antenna base 10b can function as another antenna element along with the antenna base 10b. In the example configuration of FIG. 26, an example is shown in which the conductor portion 100 is provided, but the present invention is not limited to such a configuration, and the first conductor 150 may penetrate through a plurality of antenna bases 10 when both conductors 100 and 200 are provided. The materials of the plurality of antenna bases 10 may differ from each other.

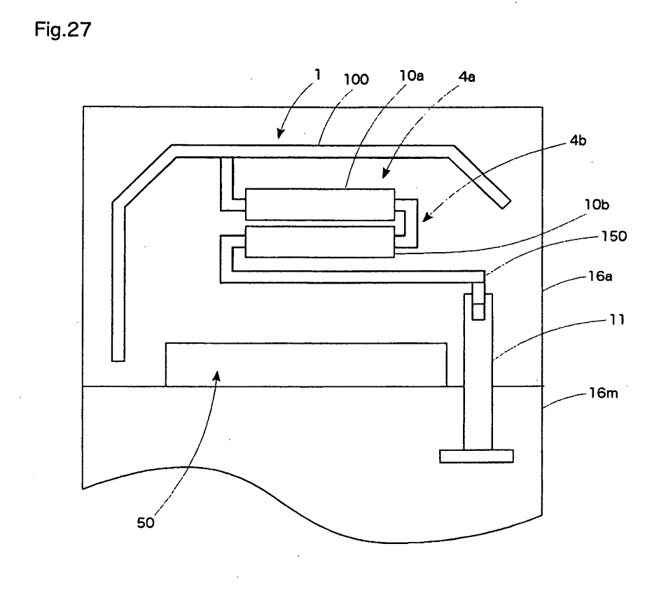

In addition, in the example configuration of FIG. 26, the plurality of bases 10 are arranged on a line parallel to the first conductor 150, but the placement may be changed depending on the mounting space such as a configuration shown in a plan view of FIG. 27 where the first conductor 150 bends in a cranked manner and the antenna bases 10 are placed in parallel to each other. In addition, by dividing the antenna base 10 into plurality of portions (such as 10a, 10b, etc.), the length of individual antenna base 10 can be shortened, the structural strength can be improved, and reliability of the antenna can be improved.

The shape of the bending path of the first conductor 150 may be a meander shape or an L-shape. Alternatively, the first conductor 150 may be placed in an arc shape.

If a dielectric is used as the plurality of antenna bases 10 of the first antenna element 4, a structure can be achieved in which the dielectric surrounds the first conductor 150 penetrating through the dielectric, and, thus, the effective dielectric constant of the antenna base 10 can be increased. If a magnetic material is used as the antenna base 10, because a structure can be achieved in which the magnetic material surrounds the first conductor 150 penetrating through the magnetic material, the magnetic field is coaxially formed with the first conductor 150 as the center, and the magnetic permeability of the antenna base 10 is increased. With such structures, a wavelength shortening effect is created in both cases where the antenna base 10 is a dielectric and where the antenna base 10 is a magnetic material, and the size of the overall antenna can be reduced.

In addition, in the above description, the ends of the first conductor 150 are described to be connected to the power supply line 11 or another conductor, but the present invention is not limited to such a configuration, and the ends of the first conductor 150 may be connected via other connecting conductors to the power supply line 11 or to the other conductors, as already described. In this case, the first conductor 150 may be formed with the overall length being a straight line.

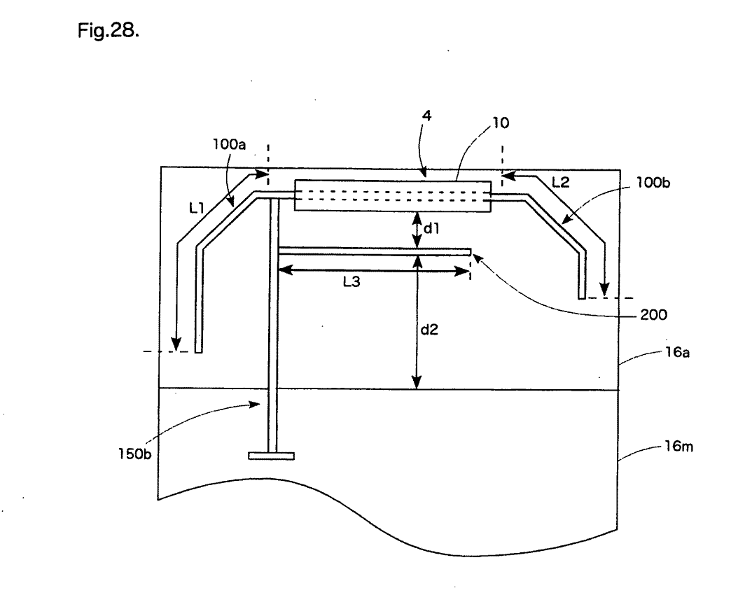

Moreover, in the above description, the first conductor 150a is surrounded by the second conductor portion and the third conductor portion, but the present invention is not limited to such a configuration. For example, as shown in FIG. 28, a configuration may be employed in which conductor portions 100a and 100b having conductor lengths of L1 and L2 are connected to the ends of the first conductor 150a and a power supply point is provided on the first end side of the first conductor 150a so that power is supplied from the main board 16m to the connecting conductor 150b. Here, an example configuration is shown in which the conductor portions 100a and 100b are bent in an L shape along the shape of the auxiliary board 16a. In addition, in the example configuration of FIG. 28, the conductor portion 200 is provided which is connected to a point on the connecting conductor 150b between the main board 16m and the power supply point of the first conductor 150a and which extends approximately in parallel to the first conductor 150a by a predetermined length L3. With such a structure, the conductor portion 100a, the first conductor 150a, and the conductor portion 100b are arranged in a shape surrounding the conductor portion 200.

In this configuration, the conductor portion 200 is provided so that a distance d1 from the conductor portion 200 to the first conductor 150a (antenna base 10) is shorter than a distance d2 from the ground surface of the main board 16m to the conductor portion 200. With such a configuration, it is possible to increase a parasitic capacitance with the antenna base 10 or the like while reducing the ground capacity, and to widen the band.

The present embodiment will now be described in more detail with reference to examples, although the present embodiment is not limited by these examples.

First, in order to manufacture the magnetic base of the present invention shown in FIG. 9A-9C, Fe₂O₃, BaO (BaCO₃ was used), and CoO (Co₃O₄ was used) which are the main compositions were prepared in a molar ratio of 60 mol %, 20 mol %, and 20 mol %, CuO shown in Table 1 was added for 100 weight part of the main composition, and the composition were mixed in a wet ball mill using water as a medium for 16 hours (Nos. 1-7).

Then, after the mixture powder was dried, the mixture powder was calcinated in the atmosphere at 1000° C. for 2 hours. The calcinated powder was crushed in a wet ball mill for 18 hours. A binder (PVA) was added in 1% to the obtained crushed powder and the mixture was granulated. After the granulation, the granulated powder was compressed and molded into a ring shape and a rectangular parallelepiped shape, and then was sintered in an oxygen atmosphere at 1200° C. for 3 hours. A sintered density, an initial magnetic permeability μ and a loss coefficient tan δ at 25° C. of the ring-shaped sintered structure having an outer diameter of 7.0 mm, an inner diameter of 3.5 mm, and a height of 3.0 mm were measured.

Table 1 shows an evaluation result of the density of the sintered structure, the initial magnetic permeability μ and the loss coefficient tan δ at a frequency of 1 GHz, and the loss coefficient tan δ at a frequency of 1.8 GHz. The measurement of the density was executed through underwater substitution, and the initial magnetic permeability/and the loss coefficient tan δ were measured with an impedance gain phase analyzer (4291B manufactured by Yokogawa/Hewlett Packard). For a part of the samples, the dielectric constant was measured with the impedance gain phase analyzer. The dielectric constant described herein is a relative dielectric constant.

TABLE 1

| | | | | INITIAL | | |
|---|---|---|---|---|---|---|
| | | VOLUME | | MAGNETIC | LOSS | LOSS |
| | CuO | RESISTIVITY × | DENSITY × | PERMEABILITY | COEFFICIENT | COEFFICIENT |
| MATERIAL | (PART BY | 10⁵ | 10³ | μ | tan δ | tan δ |
| No. | WEIGHT) | (Ω · m) | (kg/m³) | (1GHz) | (1 GHz) | (1.8 GHz) |
| 1 | 0 | 35.6 | 4.52 | 2.1 | 0.01 | 0.11 |
| 2 | 0.2 | 31.9 | 5.12 | 2.1 | 0.02 | 0.12 |
| 3 | 0.4 | 23.3 | 4.82 | 2.2 | 0.02 | 0.26 |
| 4 | 0.6 | 25.9 | 4.84 | 2.8 | 0.01 | 0.12 |
| 5 | 1.0 | 2.3 | 4.91 | 2.7 | 0.03 | 0.13 |
| 6 | 1.5 | 1.1 | 4.92 | 3.1 | 0.04 | 0.09 |
| 7 | 2.0 | 0.7 | 5.05 | 3.4 | 0.06 | 0.08 |

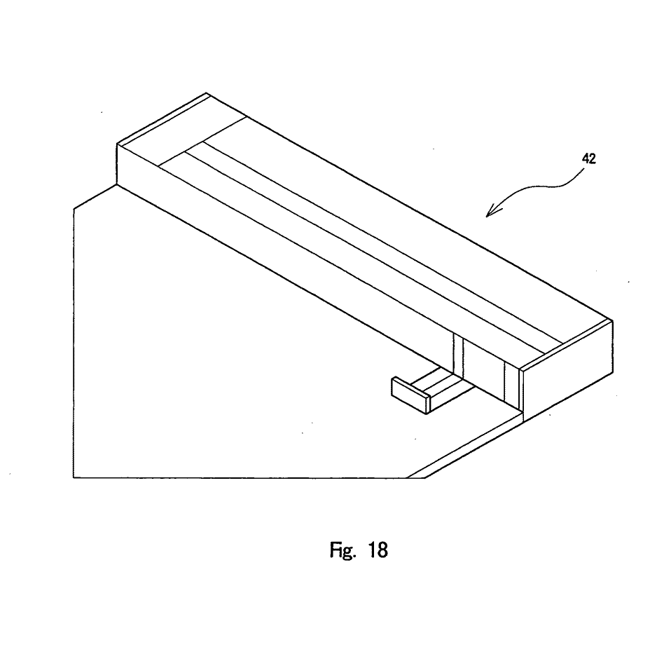

As a result of an X-ray diffraction, it was found that, in the materials of Nos. 1-7, the constituent phase having a maximum main peak intensity was a Y-type ferrite and the Y-type ferrite was the main phase. As shown in Table 1, with the Y-type ferrite to which CuO was added in 0.1 wt %-1.5 wt %, an initial magnetic permeability of 2 or greater and a loss coefficient of 0.05 or less were obtained at 1 GHz. In addition, the volume resistivity was 1×10⁵Ω·m or greater and the sintered structure density was 4.8×10³ kg/m³ or greater, which were superior values. Among these materials, in particular, the material to which the CuO was added in 0.6 wt %-1.0 wt % achieves a high initial magnetic permeability of 2.7 or greater, a low loss coefficient of 0.03 or less, and a high density of 4.84×10³ kg/m³ or greater. In addition, it was found, as the condition for achieving an initial magnetic permeability of 2.7 or greater and a low loss coefficient at both frequencies of 1 GHz and 1.8 GHz, that the sample of No. 4 was suited. Therefore, a material was selected as the magnetic base of the present invention based on the sample of No. 4 having a high density, a high initial magnetic permeability, and a low loss coefficient at both frequencies of 1 GHz and 1.8 GHz. A relative dielectric constant of the sample of No. 4 was measured and was 14. The material of the base of the structure of the related art shown in FIG. 18 is a glass/epoxy-based resin, with a relative dielectric constant of 4.6 and a dielectric loss of 0.001. The relative dielectric constant of the sample No. 4, which is 14, is sufficiently large even in comparison to the structure of the related art.

An antenna element with a magnetic base was manufactured in the following manner using the sintered structure of the material of No. 4 and through a method shown in FIG. 11. With a mechanical machining from the sintered structure, magnetic members were obtained having a rectangular parallelepiped shape with a size of 30 mm×3 mm×1.25 mm and a size of 30 mm×3 mm×1.75 mm. For the magnetic member of 30 mm×3 mm×1.75 mm, a groove was formed at a center in a width direction on a surface of 30 mm×3 mm, along the longitudinal direction, with a width of 0.5 mm and a depth of 0.5 mm. After a copper line with a cross section of 0.5 mm×0.5 mm and a length of 40 mm was inserted as the conductor in the groove, the magnetic member of 30 mm×3 mm×1.25 mm was adhered with an epoxy-based adhesive (Aremco-Bond 570 manufactured by Aremco Products, Inc.). The adhesive was applied on the affixing surfaces of the magnetic members.

With the provision of the groove in the magnetic member, a through hole having a height of 0.5 mm and a width of 0.5 mm was formed, and the base obtained by the adhesion had a size of 30 mm×3 mm×3 mm. An antenna element having a copper line which is a conductor projecting from an end surface of a magnetic base was thus obtained. In the actual mass production of the antennal element with the magnetic base, similar to the above-described manufacturing method of the magnetic base, the antenna element can be manufactured by granulating the magnetic material powder comprising Fe₂O₃, BaO, CoO, or the like through the above-described method, extruding and molding the granulation along with the conductor into a hollow rectangular parallelepiped shape, sintering the granulation, and inserting the conductor into the hollow portion.

Although in the above-described manufacturing method of the magnetic member, only the magnetic material powder was used and mixed and sintered, it is also possible to mix and solidify a magnetic material powder and a resin material and use the composite member as a composite magnetic member. In this case, by solidifying with the resin, it is possible to improve the strength compared to a structure with only the magnetic material powder. In addition, because the mixture ratio of the magnetic material powder and the resin material can be changed, the density of the magnetic member can be easily changed.

Next, in the manufacturing of the conductor portion of the present invention shown in FIGS. 1-8, 12, and 17, a plate-shaped sheet metal was used, and Cu was selected as the material in consideration of the processability. The shape was set to an approximate L shape matching the shape of the inner surface of the housing shown in FIG. 17A-17C, and the end portions were extended along the inner edge of the housing. In this process, in the conductor portion, both ends of the conductor of the antenna element comprising the base and the conductor were connected to a partway on the conductor portion via the connecting conductors and the equivalent shape of the antenna was formed in an approximate T shape.

The actual sizes of the antenna a as shown in FIG. 3 were, for example, as follows. The overall length of the conductor portion 100 of the second antenna element 1 on the power supply side of the base 10 was 37 mm with the horizontal portion being 28 mm, the vertical portion being 7 mm, and the corner portion being 2 mm, the height was 4 mm, and the thickness was 1 mm. The overall length of the conductor portion 200 of the third antenna element 21 on the non-power supply side of the base 10 was 17 mm, with the horizontal portion being 8 mm, the vertical portion being 7 mm, and the corner portion being 2 mm. A total length of the two conductor portions was 55 mm, the height was 4 mm, and the thickness was 1 mm. A distance between the ends of the two conductor portions in the horizontal direction was 3 mm. Regarding the size of the base 10, the length was 30 mm and the cross section was 3 mm×3 mm. In order to reduce the influence by the capacitance coupling with the transmission/reception circuit or the ground, the distance W between one side of each of the conductor portions 100 and 200 which are parallel to the ground portion end 40a and the ground end 40a was set at 8 mm and the distance W1 between a tip portion of the conductor portions 100 and 200 in the vertical direction and the ground end 40a was set at 1 mm.

A relationship between the lengths of the antenna elements and the frequency bands will now be described with reference to FIG. 3. Regarding the DCS/PCS band, the overall length of the conductor portion 200 on the power supply side of the base 10 was 37 mm, which corresponds to approximate λ/4 of 1800 MHz, and a resonance can be realized in the DCS/PCS band. In particular, regarding the UMTS band, although the UMTS band has a slightly higher frequency than the DCS/PCS band, because the one side of the conductor portion 200 and the base 10 are close to and parallel to each other, a capacitance coupling occurs between the opposing surfaces resulting in a multiplex resonance and widening of the band, and, thus, the resonance of the UMTS band can be easily realized. With regard to the GSM band, the total length of a length of 20 mm which is a total of the overall length of the conductor portion 100 on the non-power supply side of the base 10 and the connecting conductor 12, the length of 15 mm which is a total of the connecting conductor 15 on the power supply side of the base 10 and the power supply line 11, the length of 30 mm of the base 10, and an effective length of 20 mm due to the wavelength shortening effect when a magnetic material having an initial magnetic permeability μ of 3 was used for the base (actual length 30 mm of the base 10×√μ was 85 mm, which corresponds to approximate λ/4 of the 850 MHz band, and, thus, a resonance in the GSM band can be realized. With such a structure, it is possible to reduce the VSWR and obtain a high gain in lower frequencies in the frequency bands of the GSM band, DCS/PCS band, and UMTS band, which cannot be sufficiently achieved by the antenna of the related art shown in FIG. 18 comprising only a conductor portion or the base (for example, an antenna element 42 on which a reverse F type antenna conductor is printed on a surface of a base made of glass epoxy). As a result, the practical band in the bands can be widened. Here, if the conductor portion 200 is removed, the vacated space can be used for securing a long length for the conductor portion 100 surrounding the base 10. Because of this, it is possible to correspond to the digital terrestrial television broadcasting band or the like having a lower frequency and a wider band than the GSM band.

Next, a performance of the antenna apparatus will be described. As an example device for the antenna performance, an antenna apparatus A was constructed in which the antenna a was mounted on the board, the first end of the antenna element was connected to a power supply electrode, and the antenna element was equipped in a portable phone. FIG. 17A-17C shows an example of equipment of the antenna apparatus A. More specifically, this is a structure in which the specific structure of FIG. 2 was realized by forming the power supply electrode, the power supply line, and the antenna elements on the board. In this example configuration, the sizes of the antenna were those described above. A measurement antenna (which is placed on the right of the antenna apparatus of FIG. 17A-17C (not shown)) is provided at a position 3 m away from the antenna apparatus A, the measurement antenna was connected to a network analyzer via a coaxial cable of 50Ω and the antenna characteristic was measured. More specifically, the horizontal direction of the board (the shorter side direction of the board) shown in FIG. 17A-17C was set as X, a direction perpendicular to the horizontal direction (the longitudinal direction of the board) was set as Y, and a direction perpendicular to these directions, that is, a direction perpendicular to the plane of the board was set as Z, and an average gain and VSWR were measured in the ZX plane. The measured frequency bands were 700 MHz-1100 MHz and 1600 MHz-2200 MHz. These frequency bands include the GSM band (810 MHz-960 MHz) and the DCS/PCS and UMTS bands (1710 MHz-2170 MHz), respectively.

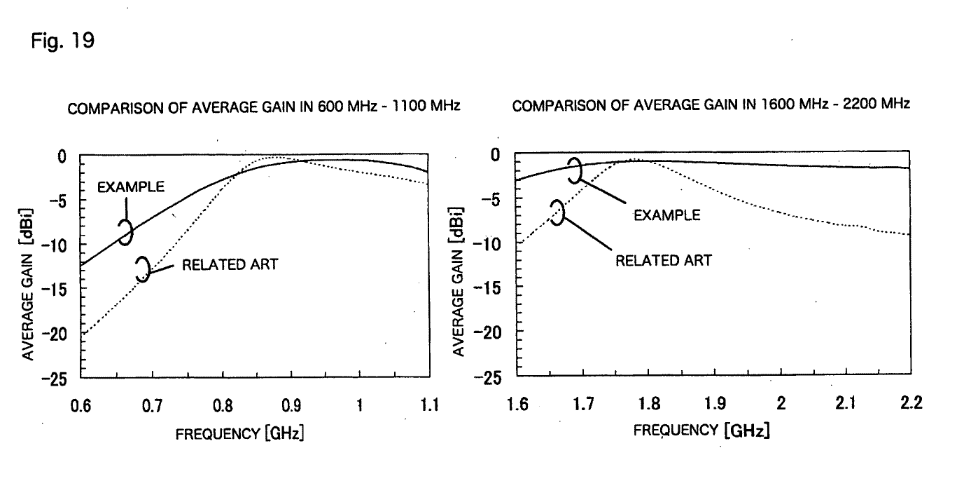

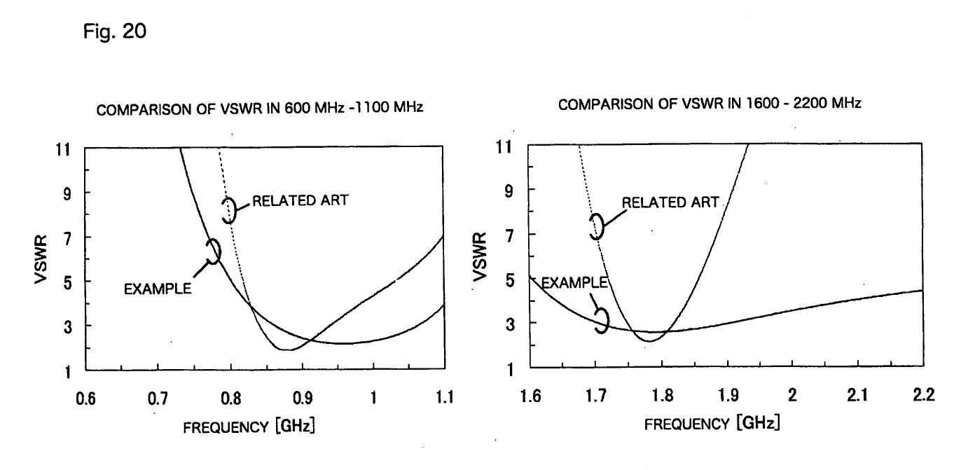

FIG. 19 shows relationships between the average gain and the frequency in the antenna apparatus A shown in FIG. 17A-17C which is one aspect of the preferred embodiment of the present invention and in an antenna in the related art 42 shown in FIG. 18. FIG. 20 shows measurement data of the relationship between VSWR and frequency in the example and in the antenna of the related art. With regard to the average gain shown in FIG. 19, the average gain is reduced on the lower frequency side and the higher frequency side of the bands in the related art, but the average gain is high even for low and high frequencies in the example. Thus, the average gain is improved over the entire band of the GSM band and the DCS/PCS and UMTS bands which are frequency bands of the portable phone. A particular characteristic is that the gain in the lower frequency side of the bands is increased. The average gain of the example is −3 dB or greater in the GSM band and −2 dB or greater in the DCS/PCS and UMTS bands, and, thus, a high gain is achieved.

With regard to the VSWR shown in FIG. 20, although in the related art, the VSWR rapidly increases on the lower and higher frequency sides of the bands, in the example, the VSWR is flat and is low in the lower and higher frequency sides and is 3.5 or less in the GSM band and the DCS/PCS and UMTS bands. Although not shown in the figures, for both gain and the VSWR, it was confirmed that, even if the graph of FIG. 20 is extended to a frequency of approximately 3 GHz, a superior antenna characteristic was obtained with flat and high gain and low VSWR.

An antenna characteristic was measured for a case in which the base portion was constructed with the above-described structure and the conductor portion was formed with a wire (line shape) in the antenna apparatus of the preferred embodiment of the present invention. In this case, it was confirmed that there was no significant difference in the gain and in the VSWR between the structure with the conductor portion having the plate shape and the structure with the conductor portion having the wire shape (line shape), and the characteristic is almost independent from the width and the thickness of the conductor portion. In other words, if the conductor portion in the antenna apparatus of the present invention is formed with a wire (line shape), it is possible to further improve the degree of flexibility of the shape of the antenna, and, a communication device using the antenna can be realized while maintaining a superior antenna characteristic over a wide band and improving the spatial usage efficiency.

According to another aspect of the embodiment, there is provided an antenna comprising a first antenna element including a base and a conductor penetrating through the base, a second antenna element including a conductor portion having a shape of a plate or a line and a connecting conductor, and a third antenna element including a conductor portion having a shape of a plate or a line and a connecting conductor. A first end of the conductor of the first antenna element is connected to the connecting conductor of the second antenna element, a second end of the conductor of the first antenna element is connected to the connecting conductor of the third antenna element, the connecting conductor of the second antenna element is connected to a partway on the conductor portion of the second antenna element, and the connecting conductor of the third antenna element is connected to a partway on the conductor portion of the third antenna element. With this structure, because the conductor portions provided at two locations on both ends of the first antenna element are formed extending along two directions with different lengths from a connection point with each of the connecting conductors, resonances of approximately λ/4 of 4 frequencies corresponding to the different lengths in two locations× two directions can be realized. In this structure, the second antenna element corresponds to the lower frequency band such as the GSM band with the first antenna element and the third antenna element corresponds to the higher frequency band such as the DCS/PCS band. For example, when the antenna of the present invention is used in two separate frequency bands such as the GSM band and the DCS/PCS band as used in the portable communication device, by providing the conductor portions with different lengths in two directions from a connection point with the connecting conductors, it is possible to provide two resonance frequencies which slightly differ from each other. As a result, it is possible to widen a frequency band in which the VSWR is low and a high gain can be obtained can be widened, compared to the case with only one resonance frequency. Thus, a superior antenna characteristic can be obtained in a wide band in two separate frequency bands. In addition, the base used in the first antenna element is not limited to a magnetic material ceramics, and an insulating material such as a dielectric ceramics may be used, which contributes to reduction in size and widening of the band.

According to one aspect of the embodiment, there is provided an antenna comprising a first antenna element including a base and a conductor penetrating through the base, and a third antenna element including a conductor portion having a shape of a plate or a line and a connecting conductor. An end of the conductor of the first antenna element is connected to the connecting conductor of the third antenna element, and the connecting conductor of the third antenna element is connected to a partway on the conductor portion of the third antenna element. In this structure, the antenna comprises a conductor portion and a base. Because the conductor portion is formed extending along two directions with different lengths from a connection point with the connecting conductor, resonances can be achieved corresponding to approximately λ/4 of two frequencies corresponding to the lengths of extension in the directions. In this structure, the first antenna element corresponds to the lower frequency band such as the GSM band and the third antenna element can correspond to the higher frequency band such as the DCS/PCS band. For example, when the antenna of the present invention is used in a higher frequency band such as the DCS/PCS band used in the portable communication device, by providing the conductor portions in two directions with different lengths from the connection point with the connecting conductor, two resonance frequencies which slightly differ from each other can be realized. As a result, a frequency band in which the VSWR is low and a high gain can be obtained can be widened compared to a structure with only one resonance frequency, and a superior antenna characteristic can be achieved over a wide band. In addition, the base used in the first antenna element is not limited to a magnetic material ceramics, and an insulating material such as a dielectric ceramics may be used, which contributes to reduction in size and widening of the band. Because a line-shaped conductor is used as the conductor in the base and the conductor penetrates through the base, a stray capacity tends to not be formed, and the magnetic material portion can effectively function as an inductance component.

According to another aspect of the present invention, it is preferable that, in the antenna, the base is provided in a plurality. That is, a structure may be employed in which the antenna element having the base is divided into a plurality of bases. In such a configuration, a plurality of conductors of the antenna elements are electrically connected in series, and one antenna is formed by an overall structure of the plurality of antenna elements. Therefore, the length of the individual antenna element having the base can be reduced with respect to the length of the base necessary for the antenna characteristic. As a result, shock resistance can be improved, and, because the antenna elements are connected in series by the conductors of the antenna elements, arrangement of the antenna element can be changed corresponding to the mounting space. Therefore, the degree of flexibility of the shape of the arrangement of the antenna can be increased, and the antenna can be mounted in a portable communication device or the like with a high arrangement efficiency.

According to another aspect of the embodiment, it is preferable that, in the antenna, surfaces of the conductor portions of the second antenna element and the third antenna element are placed standing perpendicular to a ground surface of a board. In such a structure, because an area in which the surface of the conductor portion and the ground portion (such as the main circuit board) opposes each other is reduced, the stray capacity is not increased, and a current of an opposite phase which cancels a resonance current generated in the conductor portion tends to not be generated in the ground portion, and, thus, the gain of the antenna tends to not be reduced.

According to another aspect of the embodiment, it is preferable that, in the antenna, each of the conductor portions and the connecting conductors of the second antenna element and the third antenna element is a metal conductive plate, a metal conductive film, or a metal conductive line. In such a structure, because the second antenna element is formed with a metal conductive plate, a metal conductive film, or a metal conductive line, more metal conductor portion is provided compared to an antenna formed solely of a chip, and, thus, an antenna characteristic having a high radiation efficiency of electromagnetic wave can be obtained.

According to another aspect of the present invention, it is preferable that, in the antenna, each of the conductor portions of the second antenna element and the third antenna element has a shape of a square bracket shape, an arc shape, or an L-shape. In such a structure, the antenna element can be formed in any of the shapes of the square bracket, an arc, or an L shape according to the mounting space. Therefore, the degree of freedom of arrangement of the antenna can be increased. In addition, because the occupied area can be reduced, such a structure is advantageous for storage in a limited space. It is also possible to provide the conductor portion in an elongated manner surrounding the first antenna element, to correspond to a digital terrestrial television broadcasting band having a lower frequency and a wider band than the GSM band.

According to another aspect of the embodiment, it is preferable that, in the antenna, the connecting conductor includes a power supply line. In such a structure, because the power supply line also functions as the connecting conductor, the power supply line may be considered as a part of the antenna element. Therefore, resonances at approximately λ/4 of the used frequency corresponding to the different lengths can be achieved also using the power supply line, which can contribute to a further reduction in size.

According to another aspect of the embodiment, it is preferable that, in the antenna, a distance between one side of the conductor portion which is parallel to a ground portion end of a main circuit board and the ground portion end of the main circuit board is in a range between 6 mm and 10 mm, and an end of the conductor portion which is closest to the ground portion and the ground portion are close to each other. In such a structure, because the primary portion of the conductor portion and the ground portion can be separated by a certain distance, a parasitic capacity which does not contribute to radiation is not increased and reduction in radiation efficiency of the antenna can be prevented.

According to another aspect of the embodiment, it is preferable that, in the antenna, the conductors of the bases provided in a plurality are connected to each other, and an overall length is arranged in a shape of a line shape, a meander shape, an L-shape, a crankshaft shape, or an arc shape. In such a structure, because the antenna elements are connected in series by the conductors of the antenna elements, the arrangement of the antenna element can be changed according to the mounting space. Therefore, the degree of flexibility of the shape of the arrangement of the antenna can be increased, and the antenna can be mounted in a portable communication device or the like, with a superior spatial efficiency.

According to another aspect of the embodiment, it is preferable that, in the antenna, the antenna element is fixed by a resin or a resin case. In such a structure, because the antenna element is fixed with a resin, shock tolerance can be improved. The resin may be filled after the antenna element is attached. Alternatively, the antenna element may be mounted on an antenna attachment member which is formed with a resin in advance.

According to another aspect of the embodiment, there is provided an antenna apparatus comprising the antenna and a board on which the antenna is mounted. In such a structure, by forming an auxiliary board in which an antenna is mounted on an individual board, it is possible to easily maintain and handle arrangement of a chip antenna.

According to another aspect of the embodiment, there is provided an antenna apparatus comprising the antenna or the antenna apparatus as a built-in structure. Such a structure may be used in a communication device such as a portable phone, a wireless LAN, a personal computer, and a digital terrestrial television broadcasting device, and such a structure can contribute to widening of a band in communications using these devices.

According to various aspects of the embodiment, an antenna including a conductor portion and a base (a magnetic material chip or a dielectric chip) is provided which is advantageous in reducing the size and widening the band. In particular, a high gain can be stably obtained from a low frequency band to a high frequency band of the portable communication device. With this structure, it is possible to provide a built-in antenna comprising a conductor portion and a base which is suited for efficient mounting within the portable communication device, and for achieving a very wide band and a multi-band. In addition, with the use of the antenna, an antenna apparatus and a communication device can be provided which is superior in the degree of freedom of the mounting space for the antenna.

While the present invention is described in terms of preferred or exemplary embodiments, it is not limited hereto.

What is claimed is:

1. An antenna comprising:
a first antenna element including at least one base and a conductor penetrating through the base; and
a second antenna element including a conductor portion having a shape of a plate or a line and a connecting conductor, wherein
a first end of the conductor of the first antenna element is connected to the connecting conductor of the second antenna element, and the connecting conductor of the second antenna element is connected to a partway on the conductor portion of the second antenna element.

2. An antenna comprising:
a first antenna element including at least one base and a conductor penetrating through the base;
a second antenna element including a conductor portion having a shape of a plate or a line and a connecting conductor; and
a third antenna element including a conductor portion having a shape of a plate or a line and a connecting conductor, wherein
a first end of the conductor of the first antenna element is connected to the connecting conductor of the second antenna element, a second end of the conductor of the first antenna element is connected to the connecting conductor of the third antenna element, the connecting conductor of the second antenna element is connected to a partway on the conductor portion of the second antenna element, and the connecting conductor of the third antenna element is connected to a partway on the conductor portion of the third antenna element.

3. An antenna comprising:
a first antenna element including at least one base and a conductor penetrating through the base; and
a third antenna element including a conductor portion having a shape of a plate or a line and a connecting conductor, wherein
a first end of the conductor of the first antenna element is connected to the connecting conductor of the third antenna element, and the connecting conductor of the third antenna element is connected to a partway on the conductor portion of the third antenna element.

4. The antenna according to claim 1, wherein
the base is provided in a plurality.

5. The antenna according to claim 1, wherein
surfaces of the conductor portions of the second antenna element and the third antenna elements are placed standing perpendicular to a ground surface of a board.

6. The antenna according to claim 1, wherein
each of the conductor portions and the connecting conductors of the second antenna element and the third antenna elements is a metal conductive plate, a metal conductive film, or a metal conductive line.

7. The antenna according to claim 1, wherein
each of the conductor portions of the second antenna element and the third antenna element has a shape of a square bracket shape, an arc shape or an L-shape.

8. The antenna according to claim 1, wherein
the connecting conductor includes a power supply line.

9. The antenna according to claim 1, wherein
a distance between one side of the conductor portion which is parallel to a ground portion end of a main circuit board on a side near antenna and the ground portion end of the main circuit board on the side near antenna is in a range of 6 mm-10 mm, and an end of the conductor portion which is closest to the ground portion and the ground portion end on the side near antenna are close to each other.

10. The antenna according to claim 1, wherein
the conductors of the bases provided in a plurality are connected to each other, and an overall length is arranged in a shape of a line shape, a meander shape, an L-shape, a crankshaft shape, or an arc shape.

11. The antenna according to claim 1, wherein
the antenna element is fixed by a resin or a resin case.

12. An antenna comprising:
a first antenna element including at least one antenna base and a first conductor penetrating through the antenna base;
a second conductor provided in a predetermined length; and
a second antenna element which electrically connects a first end of the first conductor of the first antenna element to a point on the second conductor at a position distanced from both ends of the second conductor by predetermined lengths.

13. The antenna according to claim 12, further comprising:
a third conductor provided in a predetermined length, and
a third antenna element which connects an end, among the ends of the first conductor of the first antenna element, which is not connected to the second conductor to a point on the third conductor at a position distanced from both ends of the third conductor by predetermined lengths.

14. The antenna according to claim 13, wherein
the first antenna element and the third antenna element are provided on a board, and
the third conductor is a plate-shaped conductor which is provided standing approximately perpendicular to a ground surface of the board.

15. The antenna according to claim 13, wherein
the third conductor is placed on the board in a bent or curved manner.

16. The antenna according to claim 12, wherein
the antenna base is provided in a plurality, and the first conductor penetrates through the plurality of the antenna bases.

17. The antenna according to claim 12, wherein
the first antenna element and the second antenna element are provided on a board, and
the second conductor is a plate-shaped conductor which is provided standing approximately perpendicular to a ground surface of the board.

18. The antenna according to claim 12, wherein
the second conductor is placed on the board in a bent or curved manner.

19. The antenna according to claim 12, wherein
the first conductor is arranged such that the overall length is in a shape of a line shape, a meander shape, an L-shape, a crank shape, or an arc shape.

20. An antenna apparatus comprising:
the antenna according to claim 1 and a board on which the antenna is mounted.

21. A communication device, wherein
the antenna according to claim 1 is built in.
